(19) United States
(12) Patent Application Publication
(10) Pub. No.: US 2011/0000206 A1
(43) Pub. Date: Jan. 6, 2011

(54) PROGRESSIVE THERMODYNAMIC SYSTEM

(76) Inventor: Torok Aprad, Oradea (RO)

Correspondence Address: TOROK ARPAD, TRANSIL VANIEL Str, no 29, bi B54, apt 54, Oradea, 410387, RO

(21) Appl. No.: 12/449,091

(22) PCT Filed: Jan. 23, 2008
(86) PCT No.: PCT/RO2008/094058

§ 371 Date: Jul. 22, 2009

(30) Foreign Application Priority Data
Jan. 24, 2007 (RO) 2007 0034
Jan. 24, 2007 (RO) 2007 00511
Jan. 15, 2008 (RO) 2008 00038

(51) Int. Cl. F02G 1/043; H02K 7/18; H02K 33/00; H02K 33/12; H02K 17/02; F25B 17/00; F24J 3/08

(52) U.S. Cl. 60/517; 290/1 A; 310/30; 310/211; 290/52; 62/476; 165/45

(57) ABSTRACT

The invention refers to a thermo dynamic system able to capture heat from the surrounding environment and transform it in mechanical energy which is to be used partially for self functioning while the rest is saved for a consumer. The system can work with any heat source, but is also designed for very small temperature differences between the warm and the cold source, which makes it fit for working with non-conventional energy, especially solar energy. The system can be used to provide heat, mechanical energy or electrical energy to both small and large consumers. The system progressively increases this pressure using compressors with liquid, with refrigerant, isochoric-isobar compressors, compressors with atomizer, with constant volume, etc absorbing the heat from the environment it is placed in using receivers, bellow receivers, magnetized piston receivers, inline engine receivers, etc, and later transforming it in mechanical energy or even directly into electrical energy, through a pneumatic engine, a double gamma Stirling engine or through a special type of caged turbine capable of working with small enthalpy falls due to the large surface of the pallets. The pressure increase in the system can be also used to power a reversed cycle thermodynamic system, giving the possibility to obtain lower temperatures than the cold source's temperature or higher than the warm source's temperature. The pressure increase in the system's compressor is mainly obtained also through a thermal transfer in a compressor with constant volume. FIG. 20 presents a system to be setup on sea surface: the whole installation is setup on some support pillars 20h, using supports 20i which are sliding with the tides transforming this energy in the rotation of an electrical generator. Series of horizontal receivers are setup on this supports: warm receivers 20j or cold receivers 20k that can be also used as a platform for technical interventions, for focusing mirrors, for caged turbines, for pressurized refrigerant tanks and other equipments. Using mobile arms 20m on the water level cold receivers are placed 20k, with the horizontal axis tangent to a circle circumference having the center in the axis of the support pillar, while the hot receivers 20j can move around a vertical axis for orientation: one side perpendicular on the wind direction and the other sides parallel to it. This way a wind turbine is achieved. On top, due to the wave movement the vertical receivers have an oscillating movement that is transformed into energy using some pistons 20e actuated by the mobile arm. At their turn, the cold and warm receivers are elements of double-gamma Stirling engines, Stirling compressors, compressors with refrigerant, compressors with constant volume, counter flow sequential heat exchangers. All of them leading to increased enthalpy of the working agent and to its transformation into electrical energy in a caged turbine.

The invention refers to a thermo dynamic system able to capture heat from the surrounding environment (where system is placed) and transform it in mechanical energy which is to be used partially for self functioning while the rest is saved for a consumer. The system can work with any heat source, but is also designed for very small temperature differences between the warm and the cold source, which makes it fit for working with non-conventional energy, especially solar energy. The system can be used to provide heat, mechanical energy or electrical energy to both small and large consumers.

In the current technical stage of development non-conventional energy sources are mainly used for obtaining heat, directly or using heat pumps. These heat pumps are working based on mechanical energy which is usually obtained from electrical energy. In the latest years, Stirling engines that can provide mechanical energy have been improved, using small temperature differences between the warm and the cold source. There are also some trials on using classical turbines, but the high temperatures and high pressure needed for them to work can be obtained from solar energy only by using a large number of focusing mirrors. The photovoltaic panels that are transforming the solar energy directly into electrical energy are more and more used. Among all the above procedures only the ones using the energy extracted as heat are truly paying out, while for all the others the pay out is real only in special conditions or considering the long term effects upon the environment due to the current price of fossil combustibles.

The thermo dynamic system described in this invention is based on the transformation of temperature difference between the warm and the cold source into a pressure increase into the motive agent. The system progressively increases this pressure absorbing the heat from the environment where it is placed and later transforming it in mechanical energy or even directly into electrical energy, through a pneumatic engine, an improved Stirling engine or through a special type of caged turbine capable of working with small enthalpy falls due to the large surface of the pallets. The pressure increase in the system can be also used to power a reversed cycle thermodynamic system, giving the possibility to obtain temperatures lower than the cold source's temperature or higher than the warm source's temperature. The pressure increase in the system's compressor is mainly obtained also through a thermal transfer. The system is extremely flexible, its components being attachable in different ways depending on the exterior conditions. The system can provide mechanical energy or electrical energy, heat or cold, according to the needs. On top, the heat produced in excess can be stored for usage when the environmental conditions are changing.

Compared to the systems presently used, the progressive thermodynamic system (PTS) has many advantages:
It can work with a good payout at a temperature difference between the warm and cold sources smaller than in the case of any present system, so it can use a wide range of non-conventional energy sources.
It has an extremely positive effect to the environment, contributing to reducing excessive temperatures and thermal pollution
Is capable to directly provide electrical energy, at different parameters, so that it can be coupled at any distribution network
Being very flexible its functioning can be adapted to different environment conditions and consumer needs, providing mainly the type of energy needed at that point in time
Even though it needs a large surface for placement, it can be placed on vertical surfaces or on the roof of the current buildings, on the surface of the darn or hydroelectric impound, on the sea or lake surface, etc. When placed on a building, this system can be perfectly integrated into the climate system of that building. In the patent request WO 2007/018443 you will find a system for thermal outer cover of the buildings with a structure perfectly adapted to supporting the building elements of the thermodynamic system (PTS).
It can be easily coupled with systems based on usage of other non-conventional energies: geothermic energy, geothermal energy, wind energy, wave energy, tide's energy

Each of its components can also work in other types of thermodynamic systems, having characteristics that can contribute to their increase of efficiency.

The drawback of this system is the large volume it occupies so the high consumption of materials needed for its manufacturing, especially if the non-conventional energy source has a low potential. However, compared to the current systems in identical environmental conditions PTS has a superior payout of the material used. Considering the positive effects its usage has upon the environment, this system can become an alternative solution even to the current technologies of energy producing from fossil combustibles.

The description of the thermodynamic system will be done based on the following drawings:

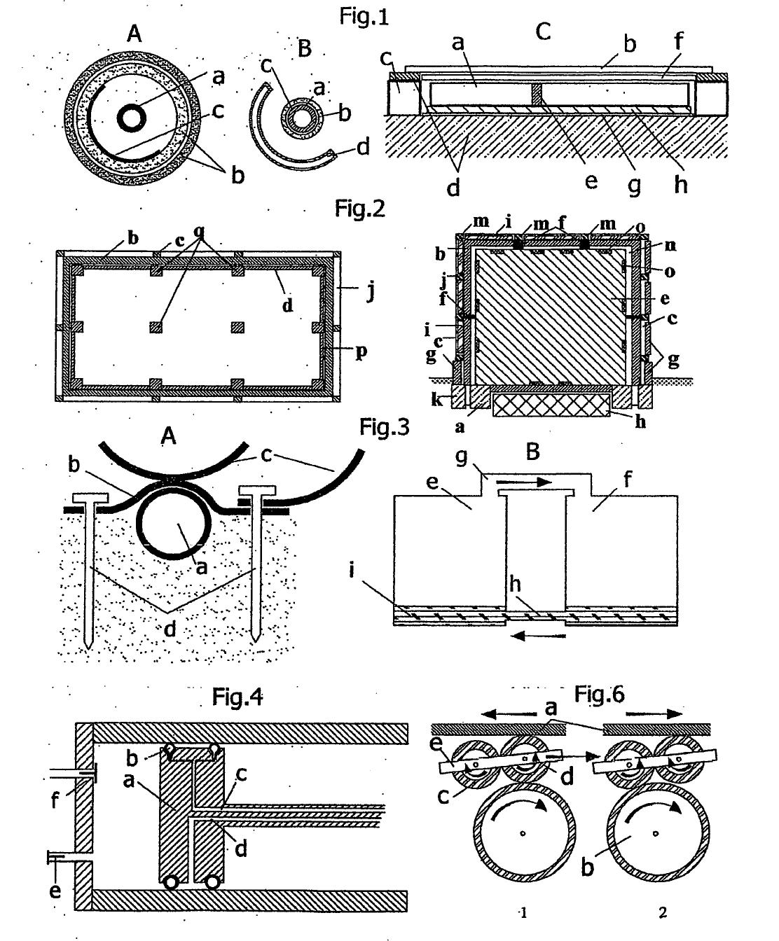

FIG. 1: Solar receiver and solar barrier

FIG. 2: Thermal outer cover

FIG. 3: Ground-fluid receiver and heat recuperator with refrigerant

FIG. 4: Piston with inflatable fitting

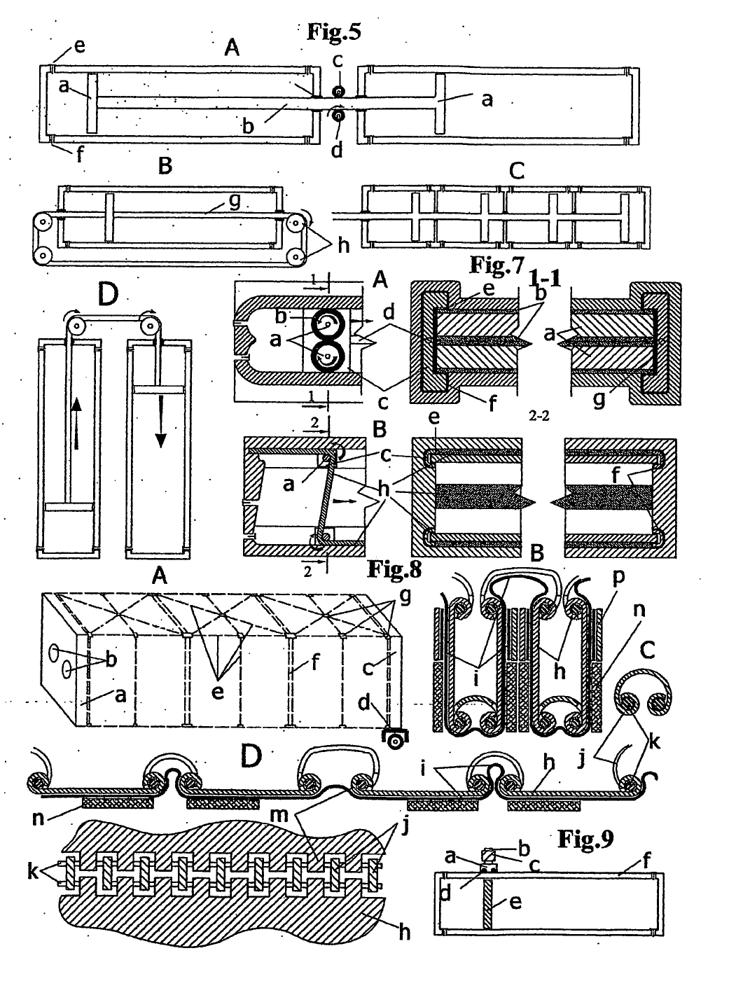

FIG. 5: Ways to actuate rod piston

FIG. 6: Dolly for changing the moving direction of the piston

FIG. 7: Pistons with travel through rolling

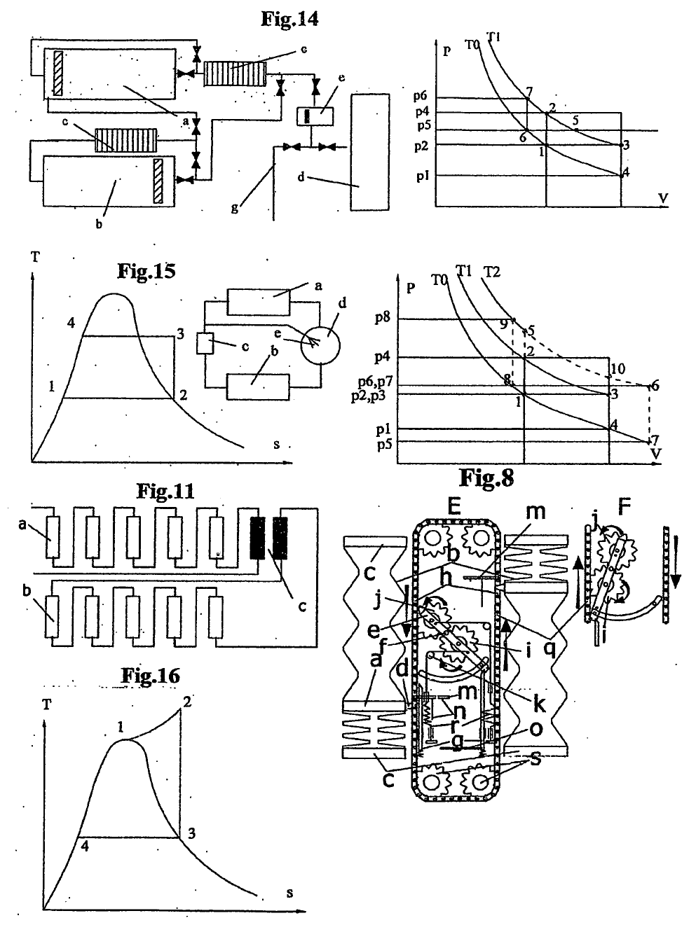

FIG. 8: Bellow receiver

FIG. 9: Procedure for piston travel through magnetization

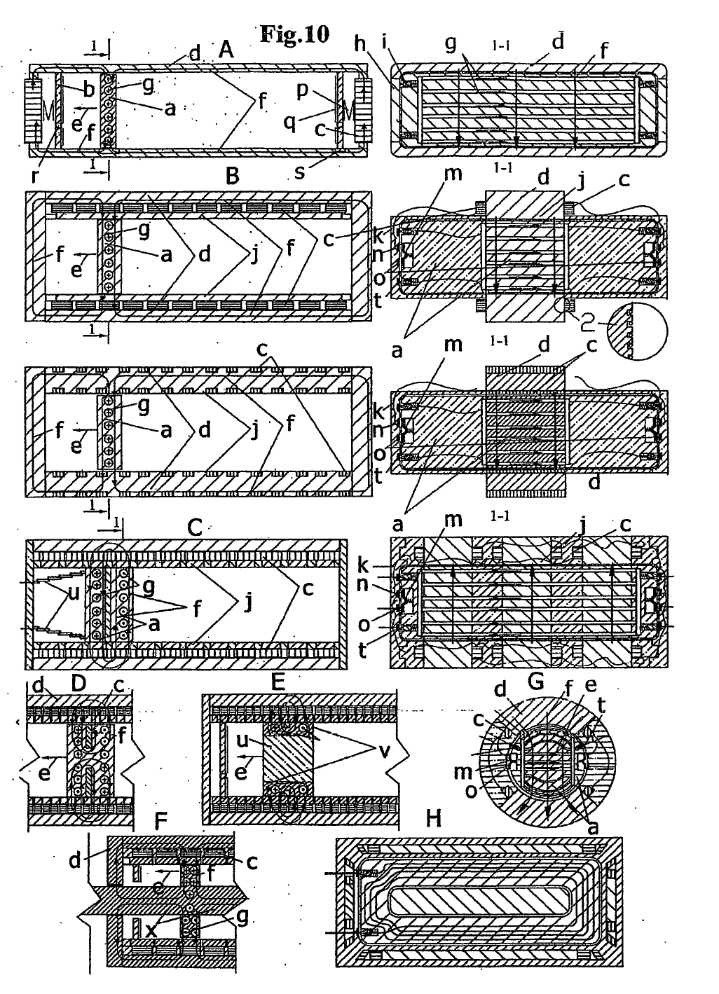

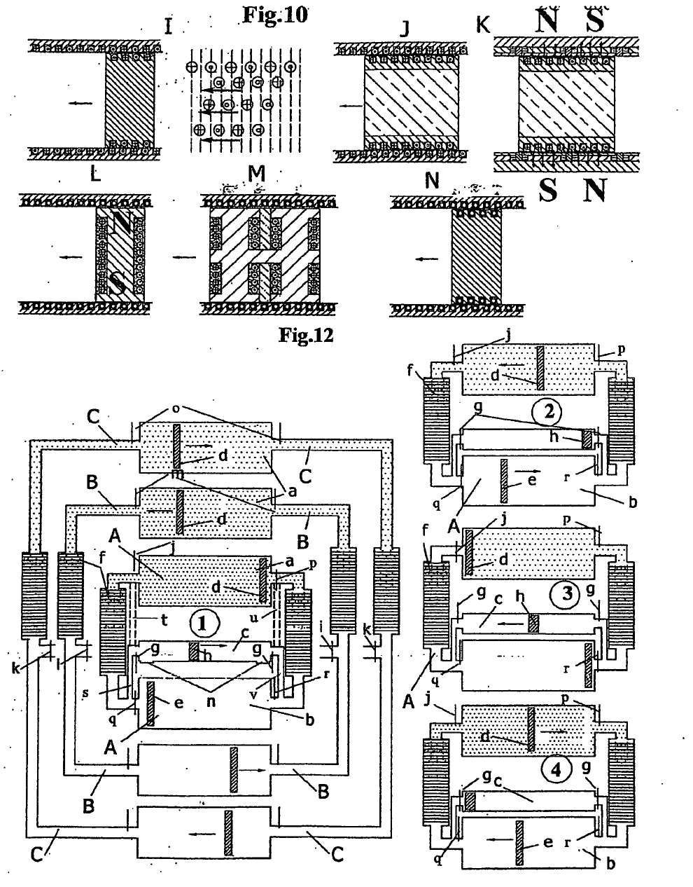

FIG. 10: Procedure for piston travel with embedded inline engines

FIG. 11: Procedure for inline engine feeding with alternating current

FIG. 12: Double-gamma Stirling engine

FIG. 13: Heat recuperator

FIG. 14: Stirling compressor

FIG. 15: Compressor with atomizer

FIG. 16: Engine T-S diagram with critical point

FIG. 17: PTS with double gamma Stirling engine

FIG. 18: PTS in closed circuit

FIG. 19: Isochoric-isobar compressor

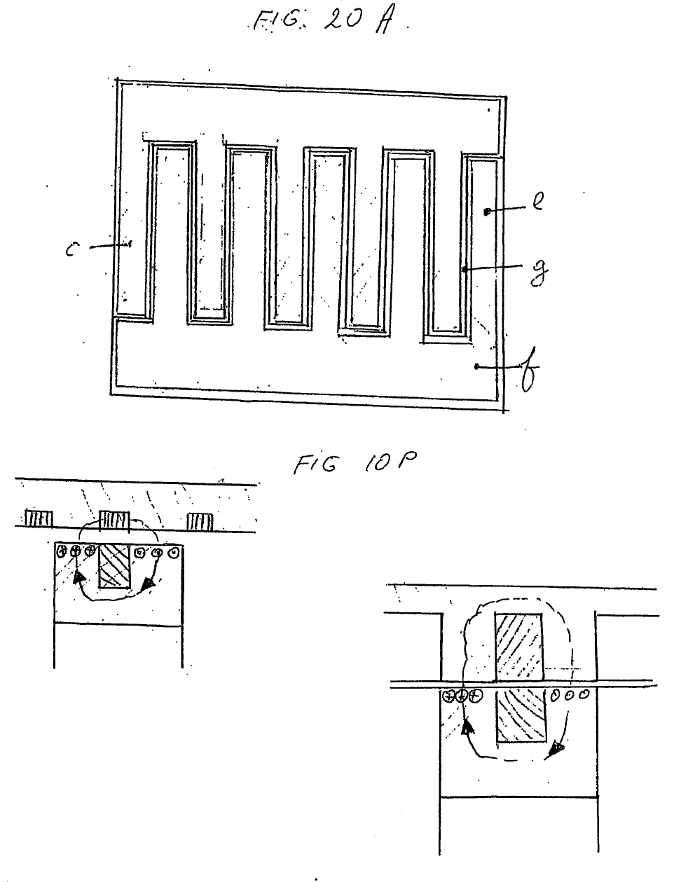

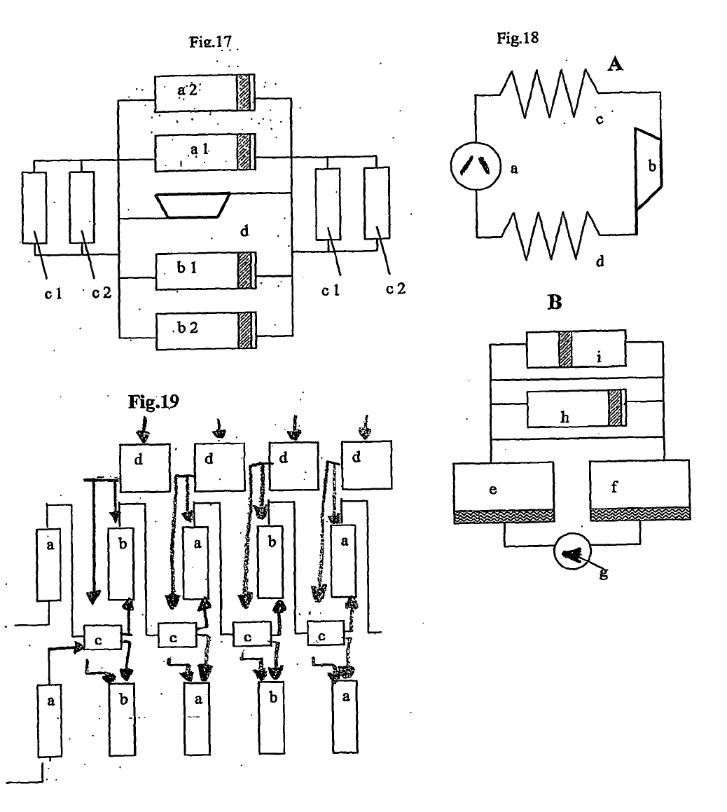

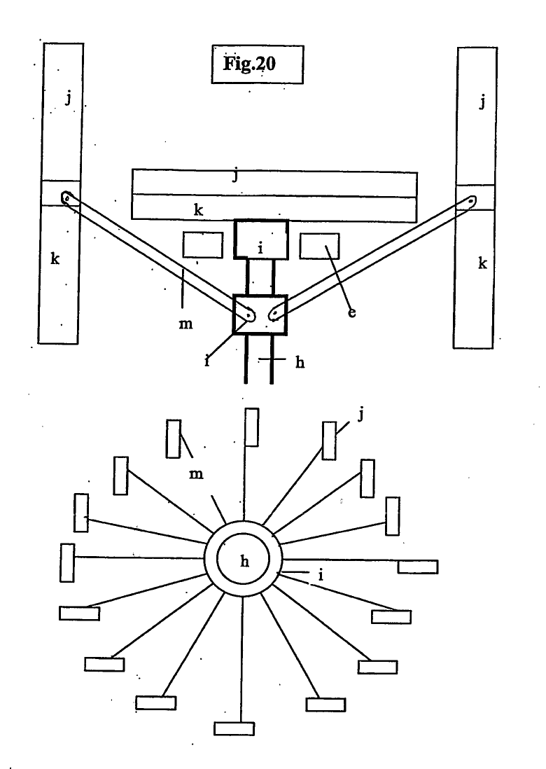

FIG. 20: Heat exchanger in sequential counter current

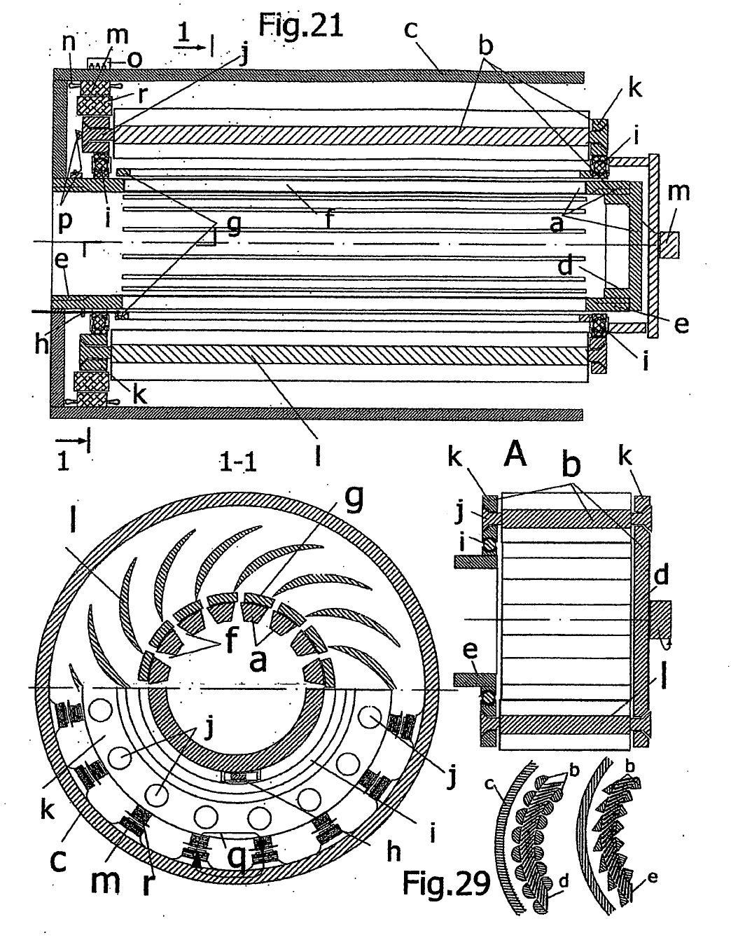

FIG. 21: Composition and construction of the radial one step centrifugal turbine, in longitudinal and transversal section

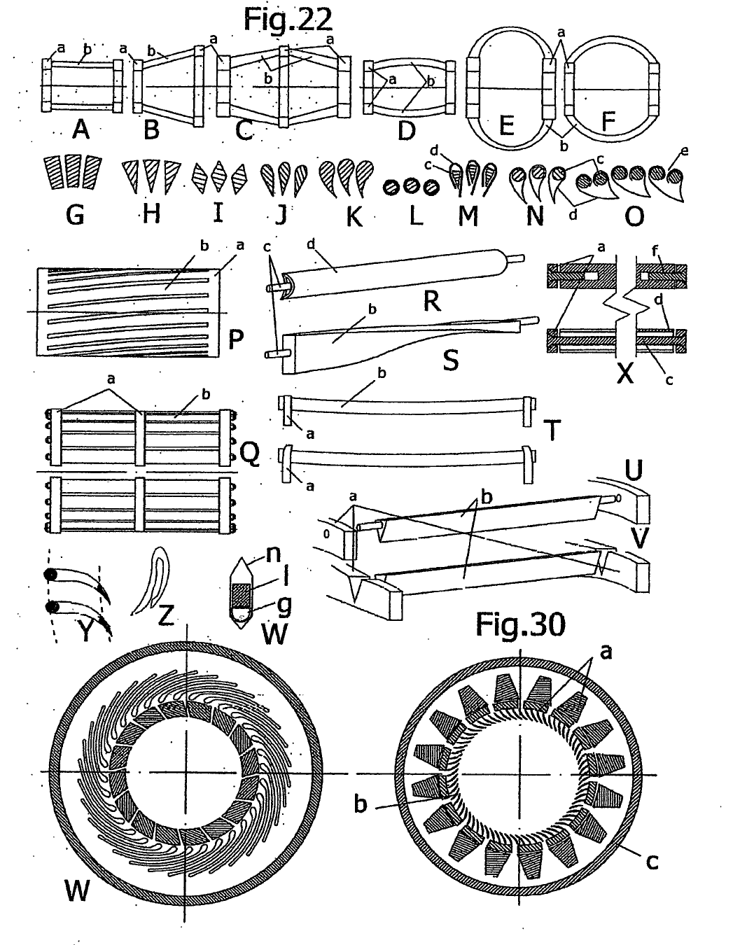

FIG. 22: The construction of building elements of the rotor and the stator

FIG. 23: Two rotor caged turbine

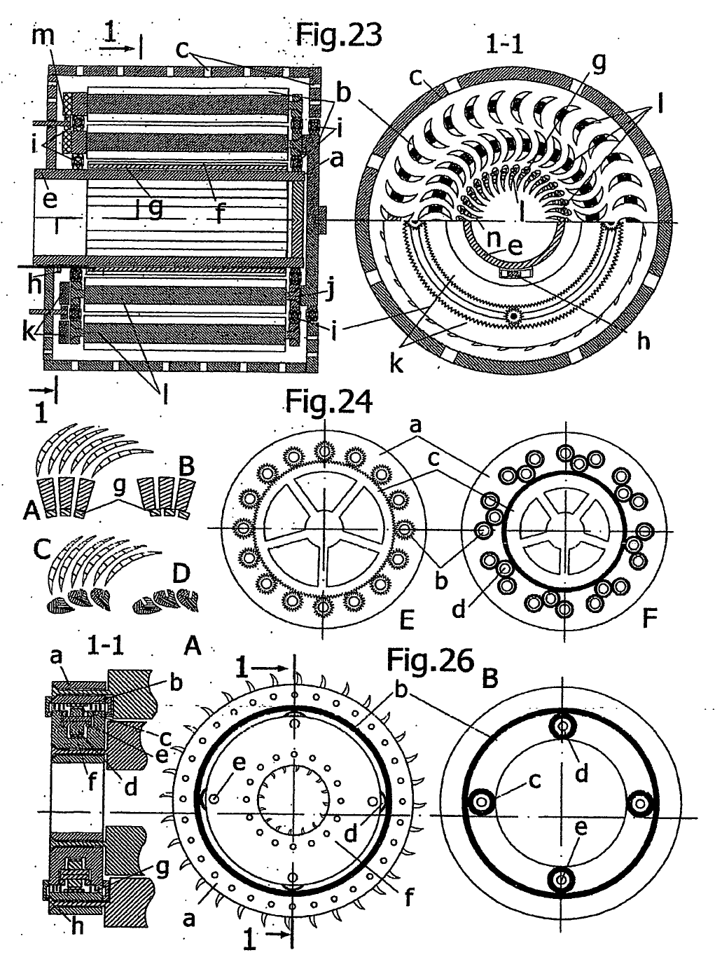

FIG. 24: Elements of the closing and adjusting system

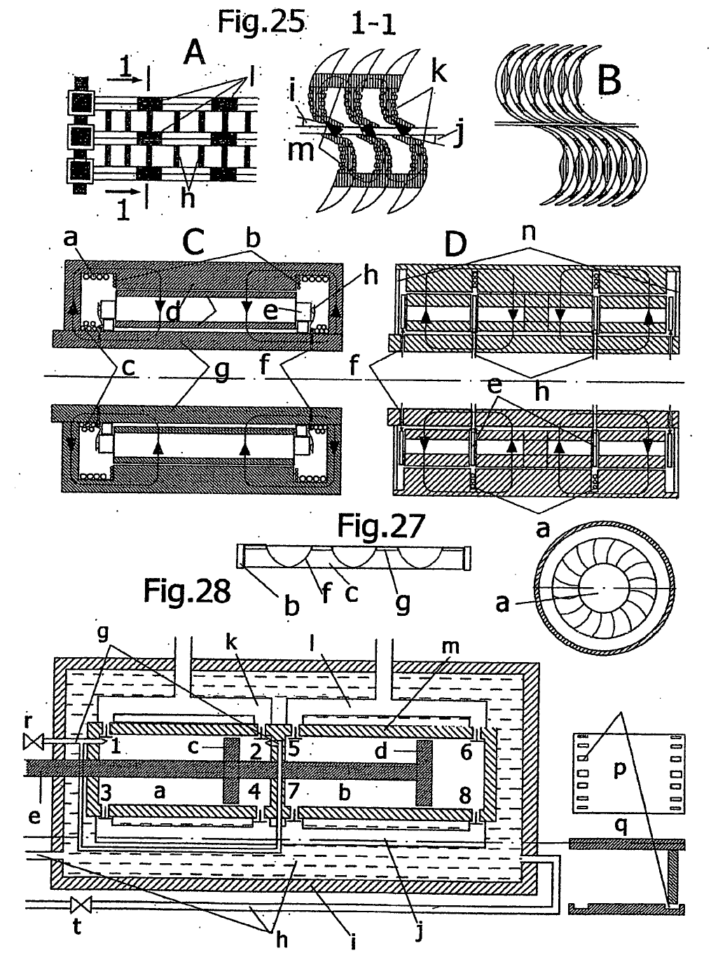

FIG. 25: Elements of embedded electrical generator

FIG. 26: Elements of turbine rotation

FIG. 27: Centrifugal caged compressor

FIG. 28: Fueling system for turbine with internal combustion chambers

FIG. 29: Reversible caged turbine

FIG. 30: Centripetal caged turbine

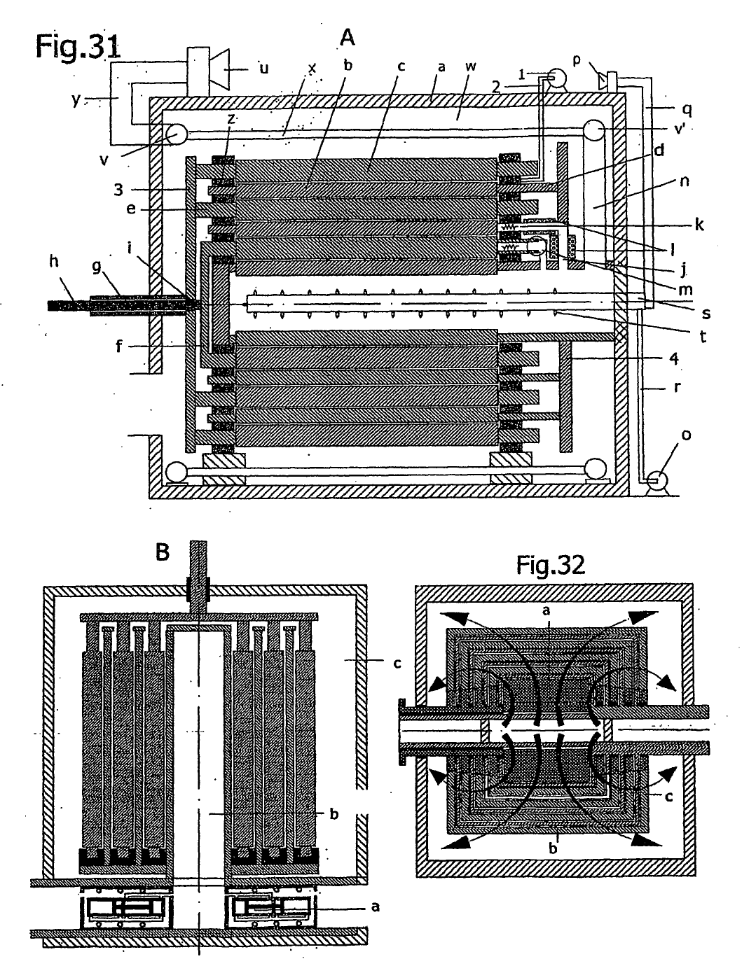

FIG. 31: Multi-staged caged turbine

FIG. 32: Radial-axial multi-staged caged turbine

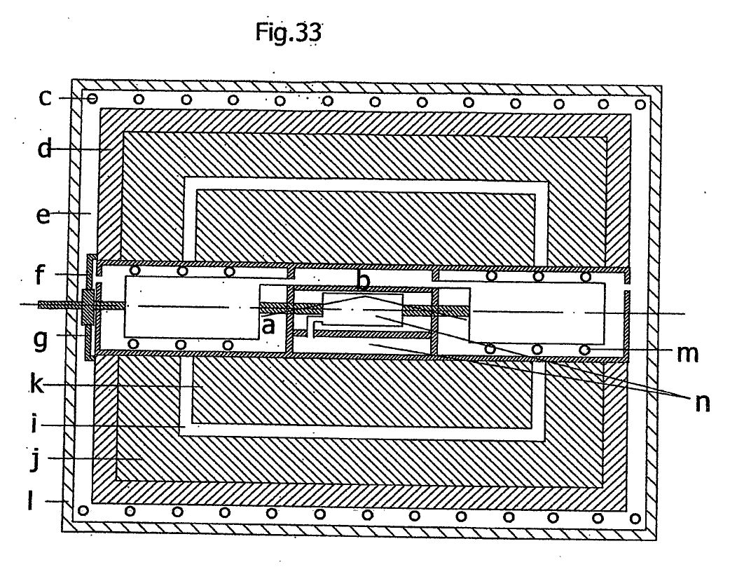

FIG. 33: Caged turbine with gases in closed circuit

### A. COMPONENTS OF PTS

1. Heat exchangers are used for:
Capturing environmental energy or from an environment with a higher energetic potential;
Transferring this energy to one of the PTS components
Disposal of the heat excess into an environment with low energetic potential, into the environment or into a heat receiver (for storage or usage)

The heat exchange is done through any of the classical systems, through a carrier agent with natural or guided circulation, usually at constant pressure. Different types of heat exchangers, vaporizers and solar panels can be used depending on: the source's temperature, on temperature difference to the cold source, on the magnitude and variation speed of this difference, as well as on different other characteristics of the thermodynamic system.

PTS uses every time when possible and economically advisable the heat recuperator with refrigerant as described in the patent request WO 2007/018443 (FIG. 3B). This is characterized by efficiency and simplicity, having a high speed for heat transfer. It is made of two heat exchangers with saturated refrigerant (3e,f), in which the liquid fraction (3i) in the exchanger occupies 10%-20% of the total volume for thermodynamic equilibrium. The two heat exchangers are placed in environments with different temperatures, for example one being inside the heat source while the other in the entry receiver of the thermodynamic system. The exchangers are linked on the superior side with a gas pipe (3g) and on the inferior side with a liquid pipe (3h). If the two exchanger would not have been coupled, the agent in each exchanger would of reach the temperature of the environment it is placed in and would of reach the pressure corresponding to thermodynamic equilibrium. By coupling the two exchangers the common pressure stabilizes at an intermediate value, for which the evaporation capacity of one exchanger is equal to the condensation capacity in the other exchanger. The intermediate pressure value is closing to the average of the two pressures if the characteristics of the two exchangers are closing to being similar. The temperature of the refrigerant is stabilizing at the thermodynamic equilibrium temperature. This way the exchanger in colder environment becomes a condenser, while the exchanger in the warmer environment becomes a vaporizer. The vaporizer's temperature becomes lower than the temperature of the environment it is placed in, so that it is absorbing heat from the environment, leading to the evaporation of a quantity of the refrigerant. The vaporized agent reaches the condenser, where it condensates with heat loss. In the same time, an identical quantity of liquid agent is moving from condenser to vaporizer due to gravitation or helped by a pump (whose on/off control is given by a level regulator). A heat exchange from the warm environment towards the cold one is happening this way, without the usage of a compressor. The equilibrium pressure is the one for which the heat transfer speed is the maximum one in the given conditions. The advantage of this type of recuperator is given by the fact that the agent transfers latent heat through movement, heat which is higher than the one cumulated by an equal quantity of agent that changes its temperature between the two limits. The agent movement in gas state is done naturally due to the pressure created through vaporization, while the movement of liquid agent is done based on gravitation when there is a favorable level difference or with the help of a pump otherwise.

If on the gas pipe between the two exchangers one is placing a caged turbine or a pneumatic engine that allows the admission of only a part of the agent's vapors, then the pressures and temperatures between the two exchangers are changed. Between the two heat exchangers appears a pressure difference able to produce mechanical work inside the thermal machine, diminishing the quantity of heat transferred between the two environments. To the extreme, all the pressure difference corresponding to the two temperatures is transformed in mechanical work and the heat transfer stops. But if on this pipe one attaching a blower or a compressor which is suctioning vapors from vaporizer and is blowing them in the condenser, both the evaporation and the condensation are accelerated. The vaporizer's temperature is decreasing and the condenser's temperature is increasing reaching a level higher than the vaporizer's. There is an increase in the temperature difference compared to the environment for both exchangers, so there is heat transfer acceleration. This compressor can be powered by a double gamma Stirling engine (or by isochoric-isobar compressor or by a constant volume compressor) having the receivers submersed in the two exchangers (or one receiver into one of the exchangers and the other into the environment). Starting form the existent temperature difference the compressor is increasing it which leads to the power increase of the Stirling engine and a vapors capacity increase, followed by a new increase in the temperature difference. The process continues until the maximum capacity of the compressor is reached.

There is an important heat source stored in the ground. 3A figure presents a procedure used by PTS to increase the efficiency of heat exchanger with horizontal pipes used to capture this type of energy. After placing them on the bottom of a hole in the ground (for placing a PTS on the ground a pipe heat exchanger is buried in the respective ground; for a new construction equipped with PTS the pipes are fixed in the pits used for foundation; for a construction equipped with a PTS combined with an Enertia Building System, the pipes are buried in the underground's floor) of a river or a lake, the pipes 3a are covered with a thin but as breadth as possible metallic tape 3b which is fixed using metallic bars 1d as long as possible (where this is possible, the whole pipe's surface is covered with a single foil or the whole pipe system is embedded into a mortar layer same as for radiant floors). The end of the bars will also have a surface as large as possible and a contact as good as possible with the metallic tape. The number of bars per surface unit depends on the soil type. This way the heat is captured from a soil layer a bit thicker than the length of the bars. On the superior side of metallic foil one can attach wings of different sizes 1c, either through manufacturing or at assembly moment using the same bars for fixation, in order to increase even more the capturing surface.

As well, PTS has a series of counter flow heat exchangers embedded, replacing the classical recuperator for Stirling engines and Stirling compressors.

2. Heat recuperator is used especially to equip the Stirling engines which work with hydrogen or an inert gas, using the types of recuperator available in the current technical stage. An improvement proposed here is to interlay small diameter pipes filled with refrigerant among the copper filaments. The recuperator is used by PTS also for capturing the solar heat, having the size smaller than for a receiver and a higher speed for heat absorption, valid also for the heat from solar radiation. This heat is given to the first solar receiver in the system, by allowing the atmospheric air through the recuperators parallel connected in areas with high solar radiation. For Stirling compressors and engines based on air, carbon dioxide etc, where the thermal transfer is much slower, counter flow heat exchangers are to be used. They can be receivers like in FIG. 5C but with double walls and having the section cylindrical or rectangular, or can be exchangers with plates. The heat exchange is done at constant volume. The two fluid paths are each split in equal volume compartments, equal also with the volume of Stirling engine receiver. Each compartment has a piston actuated with a rod as in FIG. 5C or with an inline engine. The exchanger is made of two rows of same number of receivers with identical volume between which there is a thermal exchange at constant volume from a receiver in the first row to a receiver in the second row, so that after a number of piston paths (that move simultaneously with the same speed in all the receivers, continuously or with breaks at the end of each path) equal to the number of receivers in a row, gas is successively passing through all the receivers in the respective row. A faster exchange is done in an exchanger with plates (FIG. 20) if each compartment is split in more layers 20c separated by the thin walls of some plates 20g from the similar layers of the compartments in the other row 20e and separated by the pistons 20e, 20f from the layers of the next and previous compartment in the same row. The cold layers are interlaid with the warm ones, each layer having its own piston or having a comb-piston moving the fluid in all layers (FIG. 20B). The movement of these pistons happens in the same time with the piston movement in the displacer receivers of the engines: the gas in one receiver is transferred in the first compartment, the one in the exchangers compartments is moved step by step from one compartment to another, changing the temperature and pressure in stages through heat exchange with the other gas flow, and the gas in the last compartment is introduced in the other receiver of the engine. As the pressure reaches equilibrium on this double circuit, the energy is only consumed to overcome the friction forces.

The exterior walls of the exchanger are entirely or partially insulated only if they can't be used for a favorable heat exchange. If this exchange can happen, the receiver can be also used for energy capturing from the environment (for the PTS placed on the building facets it's advisable to place the hot receivers on the South side, the cold receivers on the North side and the heat exchangers on the East and West sides), which leads to reducing the number of compartments for the exchanger.

3. The receiver is meant to introducing energy in the system. It is also a heat exchanger, usually at constant volume, having the walls made of the materials and in the shape most fit for this destination. It also has a displacer piston which transfers the gas from the receiver and in the same time it allows gas to enter in the neighbor chamber. Its manufacturing and work is similar to the one of the other components of PTS: double effect compressor where the piston actuated by a motive force is compressing the gas in the first chamber and the pneumatic engine where the piston actuated by the expansion gas entered through the admission valve creates useful mechanical work. Hence the three elements will be described simultaneously. As well, the receiver is a component part of other PTS elements: the double gamma Stirling engine, the Stirling compressor, the compressor with atomizer and the isobar-isochoric compressor.

The receiver is usually made in the shape of a cylindrical or parallelepiped tank, but can take the shape of any translation body that has the same section in all planes perpendicular on the translation axis; so that a piston can move inside it (FIG. 4) without allowing the thermal agent (air, helium, carbon dioxide, refrigerant or a different gas) to pass from one side of the piston to another. The cylindrical form is preferred in the gas of high internal pressures. If large capturing surfaces are needed (especially in the case of solar barriers) a parallelepiped shape (with rounded corners to allow the assembly on the piston of seals O-ring type) is preferred, with reinforcement rifts and wings to increase the surface of thermal exchange. If the tank needs to execute a movement in air or water during it's functioning, it will have an aerodynamic, respectively a hydrodynamic shape. The interior walls are well polesshed and built with internal channels for lubrication (if this is not exclusively done through the internal channels of the piston, 4d). The piston is built with one or more packing 4b (preferably two) placed in channels built on its circumference. These packings can be inflatable (can have an internal chamber where air or another gas is introduced through manufacturing or through a channel 4c, built inside the piston body 4a, adapting the sealing quality through change of pressure inside the packing). Each compartment of the tank is built with one intake valve (FIG. 4e, 5e) and one exhaustion valve (4f, 5f), which are both turning on and off automatically due to the pressure differences between the interior of the tank and the equipment the pipe is coupled to. In many cases, instead of valves one can use mechanical or electrical actuated taps. Between each cap and the corresponding face of the piston one can place a system of articulated bars which can fold in a hole especially created for this purpose in the cap of the cylinder. On these bars one can put flexible electrical conductors, flexible or articulated pipes with thermal agent, wings, ribs or filaments for accelerating the thermal exchange.

A one-chamber shape is also realizable (FIG. 4), with one open end and one simple effect piston, but for an efficient usage of the materials and available space the dual-chamber tank is preferred, closed at both ends and with one double-effect piston (FIG. 5A). In the entry receiver the thermal agent is introduced through the intake valve by moving the piston from one end of the tank to the other, and is exhausted through the exhaustion valve at one movement of the piston in the opposite direction. In the dual chamber receiver the intake of the agent in one chamber is done in the same time with the exhaustion of the one from the neighbor chamber. In this case a sealing of the hole through which the piston rod crosses the tank's cap is needed.

In both cases, the piston rod needs a moving space outside the tank as long as the tank's length, even more if the piston is actuated by a rod connecting a flywheel or a crankshaft. In FIG. 5 there are examples of few procedures to actuate the piston used by PTS for an efficient usage of the available space. In FIG. 5A the pistons of two dual chamber receivers placed on the same axis are actuated by the same rod 5b pressured by the wheels 5c and 5d from opposite directions. The wheels are covered with adherent material. For creating a larger contact surface the rod is made with a rectangular section with rounded corners for a good sealing when passing through receiver's end. In the figure the movement of the pistons in one direction or another is ensured by the rotation in the right direction of the motive wheel 5d, while the other wheel is making the counter-pressure needed to stop the torsion of the rod. The systems where both wheels are motive simultaneously (with opposite direction for rotation) or alternative (each wheel on one direction of the piston path) are also practical. Changing the rotation direction of the motive wheel can be made by changing the rotation direction of the actuating engine (be it electrical or pneumatic engine) or by interlaying an additional wheel with unitary transmission report into the cinematic chain, as in FIG. 6: the motive wheel 6b is always rotating in the same direction; at moment 1 it presses and rotates the wheel 6d through the adherent rim, moving through it the piston 6a to the left; when the piston reaches the end of the path, an actuating device moves the trolley 6e on a direction parallel with the piston path. The wheels 6c and 6d having equal diameter are placed on the trolley through adherent contact; the wheel 6d looses the contact with the motive wheel and the piston stops; the trolley moves until moment 2, when the wheel 6c reaches adherent contact with the motive wheel from which it takes the rotation movement and transmits it further to wheel 6d changing its rotation direction and causing the piston to move to the right. Depending on the force needed to move the piston, the cinematic chain can be executed with rims and adherent wheels or with gears and chain strand roller.

In the FIG. 5B, the massive rod is replaced by one ore more flexible rods 5g: a cable with circular or rectangular section, with the ends fixed on the two faces of the piston, rolled on 4 slotted wheels out of which at least one is a motive wheel. The flexible rod is also used for a vertical movement of the piston to compensate the weight of the piston with the weight of another piston that executes a movement in opposite direction in a neighboring receiver (FIG. 5D).

In the FIG. 5C the simultaneous movement of all pistons is realized through a single rod and actuating mechanism by attaching head to head of several equally sized receivers.

The exterior forces causing the forward-backward movement of the receiver's piston are very small, hence the friction forces can't be neglected and have to be reduced as much as possible even when the movement of the piston is slow and even when the pressures on the two faces are equal. For the receivers with rectangular section with the much longer than wider (solar receivers) PTS is using pistons for which the friction forces along its long side are replaced with a much smaller rolling force. FIG. 7A represents a receiver whose piston is made of two cylinders 7a, with the length a bit smaller than the distance between the internal side walls of the receiver, placed on two trolleys 7c each sliding through the channels in the lateral walls and having the packings 7f. The cylinders are covered with an adherent material or have an inflatable tire along their entire length and are tangent among them and one of them is tangent with the inferior wall while another is tangent to the superior wall. The ends of the cylinders are introduced using packing in holes made in the trolleys and are placed on the bottom of this holes through the packings 7g. The movement of the piston can be made through a rod 7d by pushing one or both trolleys as well as using a small engine placed on the trolley. The receiver in FIG. 7B has a flexible belt 7h instead of piston, with the same width as the receiver's and the length equal to receiver's length plus receiver's thickness. At the end of the path this belt fits closely on the cap and on the inferior wall of the receiver being slightly tensioned due to the two cylinders 7a placed on the trolleys 7c moving in the channels made in the 4 corners of the receiver. One or both trolleys are moved toward the opposite cap of the receiver through rods or using a micro engine. The flexible belt whose ends are fixed into the receiver's walls is detached from receiver's cap opening the valve in the end (in the same time with the opening of the valve on the opposite end) and molding on the superior wall progressively while detaching form the inferior wall, the margins of the belt sliding on the lateral walls, hence creating the two chambers of the receiver.

4. The receiver with bellows. The sliding friction can be completely eliminated when the receiver has accordion like folding walls. The folding walls are placed between the piston 8c and one or both ends 8a of the receiver having the valves 8b (FIG. 8A). In the first variant the cap and folding walls are placed inside a closed chamber with rigid walls, which will be the second room of the receiver reaching maximum volume when folding walls are folded and a minimum volume (the dead space) when they are un-folded. In the open variant (second one) when the piston moves (through sliding or using wheels 8d to transform translation in rotation movement), the walls between piston and a cap are folding compressing or exhausting the gas inside, while the walls on the opposite side are unfolding increasing the volume of this compartment. There folding is done inwards such that the folds of the superior walls 8p get between the folds of the side walls 8h. After a complete folding the dead space should be as small as possible, adding on the inner walls filling material 8n is also helping that. An example of building such walls is presented in FIG. 8. The folding walls are made of soft materials (rubber, polyethylene, textile metallic or impregnated cloth, etc) if the pressures are small or are made of tough materials covered on the entire, surface or only on folding edges (exterior folding edges with the movement in a single plane 8f or interior folding edges with the movement in multiple planes 8e) with soft materials to ensure the sealing. These materials have to remain intact at a high number of folding-unfolding cycles. On the folding edges 8e, 8f, but especially when several edges are intersecting 8g an additional space needs to be secured to ensure a free movement so that the sealing material is not overloaded above a certain limit. In FIG. 8 the receiver's walls are made of a metallic plate, having the sides cut to form a teeth series 8m which are then bended on a cylindrical surface. A rod 8k is introduced in the cylindrical holes thus formed so that the wall can rotate around it. Two contiguous walls 8h are linked with ears 8j made also from plate and having holes at both ends for introducing the rods. The shape and size of these ears are chosen such that after their assembly there is a free space created between two walls to allow the sliding of the sealing material and if needed of the folds of the contiguous walls. The sealing of the receiver is done by attaching on the interior walls of a rubber carpet 8i. The attachment is done only on the flat part of the walls so that on the sides at the joint of two walls the carpet can move freely. FIG. 8B represents few of these walls of a folded receiver; FIG. 8D represents same walls after the complete unfolding of the walls. In the first case on the inside folding edges the carpet is flattened (with a small reserve to avoid over tensioning) while on the exterior edges the carpet forms a loop protected by the fixing ears. While the walls are folding, the loop on the interior edges is increasing while on the exterior one it is decreasing. This type of receiver is extremely useful when the thermal agent shouldn't touch the oil used for piston lubrication. On top, with no rod the receiver is perfectly sealed and the piston movement is done through mechanisms placed outside that have the volume occupied much smaller than in the case of rods actuated by a push and pull system. In FIG. 8E is presented an example for powering this system. As the receiver is a vertical one it is powered together with the piston of an identical receiver with bellows to compensate the weight of piston 8a and walls 8b. Both pistons are mechanically coupled through ears 8d to strand of a chain strand roller 8q, rolled on the gears 8s which also ensure the straightening of the chain. The actuation of the chain is done by the gear 8i attached on a trolley 8e oscillating around an axis 8f. On the same trolley an engine is placed which in FIG. 8E rotates clockwise the gear 8i which causes the counterclockwise rotation of the gear 8j. In the position presented in the figure the gear 8j is coupled with the chain determining its movement, hence determining the movement of the piston of the first blower towards the inferior cap 8c and the movement of the second bower's piston towards the superior end. The trolley's position is given by a system of springs 8r and arresters 8g. Its position change is done by the spring 8r linked at one of the ends with one of the trolley's arms through a cable and a stretching wheel 8k. Moving the chain downwards moves in the same direction the arm 8m on which there are two bumpers 8n: the longer bumper reaches at a point in time the stretching disc of the spring 8r leading to its tension and in the moment the piston reached its final position the short bumper reaches the arm 8o of the arrester. This leads to the trolley being freed and transitioned in the second work position (as per FIG. 8F), where the trolley is blocked by the second arrester actuated by a spring. The position change of the trolley determines the detachment of the gear 8j from the chain, so temporary stopping the strand roller chain and establishing a direct couple between the chain and the motive gear 8i. The clockwise movement of this wheel didn't stop, hence the first piston starts its ascending move while the second piston starts the descendant move until the second arm with bumpers reaches the inferior position and is tensioning the second spring, freeing up the arrester.

5. The receiver with magnetized piston. Another procedure used by PTS for piston's movement is the usage of magnetic or electrical forces, eliminating the problems related to sealing of the rod and to the space for its movement. In the current stage of development this type of procedures are usually based on permanent magnets, non-economical procedures considering the number and size of the receivers and cylinders in the system. FIG. 9 presents a receiver whose piston 9a is manufactured from ferromagnetic material and whose walls 9f are manufactured from diamagnetic or paramagnetic materials. A polar element 9a can slide or roll using the wheels 9d on one or more exterior walls (for the pistons with rolling on the walls where trolleys are placed). The polar element 9a is part of the same body with the core 9b of a coil 9c powered by direct current and causes the piston magnetization. The movement of this polar element leads to the movement of the piston as well. Another advantage of this configuration is that all auxiliary devices (rods, micro engines powering cables, catchers, breaks, etc) are also placed in the exterior of the receiver. The device is reversible: when the piston is moving due to the pressure difference between the two chambers it causes the movement of the polar piece which in its turn can power a mechanical device or can generate electric current in a linear generator placed parallel with the receivers axis (the exterior wall on which the polar piece is moving can be the stator of the linear generator) or in a rotative generator placed in the wheels used for movement.

6. The inline engine receiver. The receiver presented in FIG. 10A is a compressor with an inline engine using direct current, with a single-poled field. The inferior and superior walls 10d are made of ferromagnetic material (entirely, as in FIG. 10A section 1-1 or only in the central area, as in FIG. 10B, or on more area, as in FIG. 10C) and they are magnetized by the coils 10c powered with direct current, with the currents having the same sign (thus generating two different poles on the two walls), placed on one or both caps. The two magnetic fluxes 10f close through the gap air formed between the walls and the piston (which can be decreased below 0.1 mm) and the piston's body 10a, also made of solid ferromagnetic material (in this case, the piston can be a path for the direct current 10g), or made of sheets. The ferromagnetic section of the piston will have the width and location corresponding to the ferromagnetic sections of the walls. In the case of a sheet made piston, there are channels made in its body in which there are inserted copper or aluminium conducting wires, perpendicularly on the course of the magnetic flux and on the movement direction. At the thicker pistons, the conducting wires can be placed in channels on its surface, on the whole area of the section. These conducting wires are power supplied with some collecting brushes 10i, placed in housings made in the body of the piston, between the two sealing, brushes which touch the side walls 10h of the receiver—if the walls are made of a good conducting material, or some thin copper lamellas 10t—if the walls are made of a non-conducting material. The interaction between the magnetic field and the current passing through the piston generates a force 10e, proportional to the value of the current in the piston and to the current in the coils, which makes the piston move towards one of its ends. The adjustment of the compression force, as well of the piston's speed, can be made by operating one or both currents that generated them. The reversal of the movement direction is made by reversing the flow of the current in the piston, or, preferably, in the coil, when the piston passes through a certain point, thus by reversing the force acting on the piston, it will be slowed down so it could stop at the end of the receiver, and after stopping—this force becoming active, it will move the piston in the opposite direction. The braking travel can be shortened in mechanical way, by placing two braking pistons 10b, featuring elastic buffers (in FIG. 10: a rubber layer 10q), at the two heads of the receiver; a spring or a elastic coupling 10p is fitted between these pistons and the caps. An opening made in the 10r braking piston or a 10s small channel made in a wall, slightly longer than the thickness of the piston allows the fitting of the valves in the cap, or right next to it and the use of the entire length of the receiver. If one fits sealing between the walls of the braking pistons and the walls of the receiver, an elastic, pneumatic cushion forms between the pistons and the cap, which generates an additional breaking (or replaces the mechanical one). In this case, the intake and exhaustion valves are fitted in front of the braking piston. When the active piston reaches the braking piston, the current in the coils is interrupted, and the kinetic energy of the piston is transferred to the buffer and to the coil (the inline engine becomes a generator); after the piston stops, it takes over the energy accumulated in the buffer and begins a movement in the opposite direction, generating electrical energy. After the complete expansion of the buffer, the coil is supplied with counter flow current an the piston re-starts its active movement in the opposite direction; The braking of the piston can be made in electrical way, by supplying the coil with a counter flow current, with controlled intensity. If there is a pause at the end of the movement, the piston is stopped by cutting off the coils from the power supply and switching over to an electrical load, for example on the supplying circuit of an adjoining piston, or a resistor which warms up the agent in a heat exchanger, or a Peltier element which cools it down. In this section, the receiver becomes a linear direct current generator. In this case too, different kinds of braking devices can be used—mechanical, pneumatic, hydraulic, magnetic (with permanent magnets) or electrical.

In the case of the receivers using warm air, the mechanical losses due to the friction, as well al the electrical losses in iron and copper are entirely recovered by the active agent, by increasing its temperature. Concerning the receivers with cold agent, the cooling of the walls of the receiver and possibly of the piston too is required, using a cooling agent with forced flow of a heat recuperator with refrigerant; or of some Peltier elements fitted in channels made in their bodies, the recovered heat being introduced again in the system.

In the 10B figure, the interior inferior and/or superior walls are the polar 10j elements of one or several rows of 10c coils (a row for each section of ferromagnetic wall, FIG. 10c, section 1-1), each row having one or several coils, with equal or different widths, and the outside walls and the two caps are the armatures through which the magnetic circuit closes. All the coils are supplied with same sign currents; forming different poles on the two walls. Their winding can be done transversely (FIG. 10B1), with the magnetic field perpendicular on the coil axis, or longitudinal (FIG. 10B2) with the magnetic field parallel with the axis getting a direction perpendicular on the piston's conductors (the rotor of the inline engine) only when the rotor reaches a position between two coils. For the transversal coils, the most efficient distribution is obtained using rows of coils having approximately the same width as the thickness of the piston, or an entire fraction of it, while for the longitudinal coils their length has to be as small as possible. This distribution is advantageous because it allows the supplying with electrical energy of only those coils which are placed right next to the piston. In order to obtain it, on one or several side walls of the receiver, on its entire length, parallel to the movement axis of the piston, two continuous 10o copper bars are fitted for, each row, linked to both terminals of a direct current power supply, and two 10n bars, composed of as many segments as the number of the 10c coils in a row, each segment having the length approximately equal to the thickness of the piston and being connected through a 10k conductor, at one of the two heads of the coil; two 10m elastic thin lamellas, placed in the side housings of the piston, pressed by a spring, establish, each of them, a path of current between the 10p charging bars and one bar segment 10n, supplying with electrical current the coil nearby the piston. If there are more rows of coils 10c, all the coils placed in the same plane as the piston can be supplied from the same 10n bar segments, through serial or parallel connections, or segmented 10n bar pairs can be set up for each row, in which case the piston has the corresponding additional lamellas. By using this method, the rows of coils can be supplied with different voltages, which make the adjustment of the speed easier. By using bar segments longer than the thickness of the piston on a row of coils, outside the coil that lies in the field of the piston, the coils placed in front or behind it can be also supplied.

The heads of the coils in the braking area are supplied directly from the source, in the same direction flow as the braking and later as the starting, thus the switching of the supplying direction is no longer necessary, only in the case of the other coils. When the gases in the receiver are flammable, or when there are problems of sealing or switching, the piston is supplied from two terminals set up in the cap, through a set of flexible cables or articulated bars system 10u. The system of current bars and brushes for the supplying of the coils is set up outside, on a trolley magnetically coupled to the piston, similar to that in FIG. 9, or it is electronically commanded by a position transducer (for example, a transducer set up on the articulated bars which supply the piston and which converts in electrical signal the angle between two bars or the distance between two points on neighboring bars).

This kind of engine is produced only for the displacer receivers (that require low actuating forces), as the current of the coils cannot increase over the limit of their saturation, and in the piston, due to the small length of the current paths, high intensities are required, which leads to a more expensive switching equipment. For the power receivers, the single-pole construction (with a simple constructive assembly and high magnetic forces) can be achieved if the piston features on one or both sides (FIG. 10F) a rod of ferromagnetic material, or if the piston slides on a ferromagnetic support having both heads rigidly fixed in the caps. In this case, both walls are polarized with the same polarity, two magnetic fluxes form and close through the rod (support), and the piston can be winded as in FIG. 10H.

The inline engines of the receivers can also be produced in the hetero-polar version, the stator being built on the inside walls of the receiver, and the rotor, usually having a single pair of poles, on one or more walls of the piston. The inline engine in FIG. 10C has a hetero-polar magnetic field, each having on each side of the piston axis two active poles of different polarities; the magnetic flux closes on a much shorter path composed of two widths and two thicknesses of piston (in this way, the caps can be made of non-magnetic materials, and the ferromagnetic portions of the walls of the receiver can be made with a much smaller section), and the current paths in the piston can be connected in series by winding. To this effect, the piston is made out of two ferromagnetic semi-pistons, separated by a non-magnetic portion, which is several times thicker than the gap air, and the 10c magnetizing coils have the width equal to the thickness of a semi-piston. On the left and the right side of the non-magnetic portion of the piston, two single-pole magnetic fields, of different signs, are formed. It is sufficient to supply, at a certain moment, with currents of opposite signs, only a couple of coils in each wall: the coils influencing more than a half of the thickness of the semi-piston. The switching should happen when the median plane of the semi-piston reaches the axis between two coils, and the segments 10n should have the length equal to the thickness of a semi-piston. It's recommended to simultaneously supply of all the three coils which influence the piston in that moment: the first coil should be supplied with current in the moment when the first semi-piston enters its action area, the second coil under which influence is the rest of the first semi-piston and a part of the second, which has already been supplied with current of that sign, should switch the direction of the current when the median plane of the piston reaches its axis (in this moment, one half of each semi-piston is under its influence), and the third coil, already supplied with opposite direction current, should cut off when the second semi-piston comes out completely of its influence (which is the same moment with the beginning of supplying the new coil); in this case, the length of the bar segments 10n is 1.5 times the thickness of the semi-piston. The electrical conductors in the piston are set up in the median plane of each semi-piston, having different directions in the two semi-pistons, these conductors being the separate bars parallel connected each to a couple of collector bars, or parallel spires connected to a single pair of collector bars, or a single coil with more spires, having two heads connected to the power supply. In the position in FIG. 10C, the plane where the conductors of the piston are placed lies in the axis of the coils and the magnetic flux is at its maximum, so does the force acting on the piston. At the left side movement of the piston, the dissipation flux increases and the pushing force decreases, reaching a minimum in the moment when the plane of the conductors reaches in the axis between two coils, when the dissipation is maximum (moment of switching), after that the active force increases again. In order to decrease the pulsations of the actuating force, as well as of the dissipation magnetic flux, we can use the method described in FIG. 10D: the thickness of the piston is increased and the width of the coils 10c is decreased, so that, at a certain moment, a semi-piston should be under the influence of several coils (three in figure), all of them supplied with current of same direction, from the moment when the first semi-piston enters under their influence, until the moment when the axis of the piston comes out of their influence. In 10E figure, another method of reducing the weight of the receiver is presented to us: the piston is fabricated of ferromagnetic material only on the areas 10v which are neighboring the wall, with the corresponding decrease of the incorporated conductors, the central area 10u being made of a lighter material. In case of even weaker action forces, it's sufficient to magnetize a narrow area of a single wall (preferably the inferior one) and the area of the piston that slides on it. In the case of a receiver with cylindrical section, the magnetic fluxes inside the cylinder are radial, and the electrical conductors in the piston form a coil in one or more concentric layers with the centre in the axis of the piston. All the versions of described direct current inline engines can be made after the same principles, regardless of the shape of the section of the receiver. For example, FIG. 10G describes a section through a cylindrical receiver.

The magnetic field of the stator can be also obtained by introducing electrical conductors in channels built in the inside walls of the receiver and by performing of an identical winding with the winding of the rotative engines with submerged poles. In FIG. 10P the rotor has two poles with opposite signs separated through a non-magnetic area, made through a looped winding (a curled winding can be also realized by connecting in series the coils in the inferior side of the piston). In this case one of the two fields (in rotor or in stator) has to change the direction when the median plane of the piston crosses through the separation axis of the stator poles, which is realized with the brushes set up on the rotor and with the linear collector set up in the walls of the receiver.

If there is no need for a rigorous control of the pistons position and its speed has to be high (for example for adiabatic compression of a high gas capacity) the receiver construction can be simplified a lot using ferromagnetic stirrups and supply bars of the piston only in the areas at the end of the piston. In this case the rotor is supplied with high amplitude pulses (short-circuit current): the electromagnetic forces that appear throw the piston towards the opposite end where it is stopped by the spring, the rotor conductors receive an opposite direction impulse and the piston is thrown in opposite direction.

The engines described an far can be also supplied with alternative current, so a rectification equipment being no longer necessary, and if the magnetized areas of the stator are at least three, they can be also supplied with three-phase current. For this it's necessary that the phase difference between the stator and rotor current should be 0 or 180 degrees (depending on the movement direction of the piston). Because usually the stator is more inductive than the rotor, a supplying in parallel is not possible. A supplying in series is possible only when the current (equal in rotor and in stator) is powerful enough to move the piston, which happens at the displaces receivers that require weak currents. When the phase difference has a value close to 60 degrees, additional impedances can be added on the stator and rotor, in series or in parallel, so that this phase difference should occur with sufficient precision, which makes possible a supplying of the coils from two different phases of the three-phase current. In the same time, due to the large number of receivers in the system, it is possible that one of these should generate alternative current (mono-phase or three-phase), with the necessary phase difference, only for the supplying of the coils of the stators (or rotors) of the other receivers in the system, and by an adjustment of its excitation, the desired phase difference can be obtained. Another procedure is described in FIG. 11: the stator coils are connected in series between them and with the primary of an electrical transformer whose secondary will generate a current in perfect phase opposition, which makes possible the supplying of the rotor coils with the adequate current.

At this type of alternative current engines, the speed of the piston is not influenced in any way by the frequency of the supplying current, only by the amplitude of the stator and rotor current.

A noticeable constructive simplification can be obtained if the stator coils are supplied with alternative current which passes through the zero value exactly when the axis of the piston coincides with the axis of the respective pole. For a piston with a pair of poles this can be obtained if the piston moves with such a speed that in a second it covers a distance representing the number of thickness of a piston equal to the frequency of the current. In this case, there are no longer necessary the systems of brushes, collectors and synchronization devices for the switch of the direction of the current. The achievement of this grievance is ensured by the linear mono-phase or three-phase engines that have the stator winding of each pole made with a sinusoidal distribution in space, generating a spinning field, and a rotor winding as in FIG. 10M for the synchronous version or 10N (cage) for the asynchronous version. The frequency of the supplying current is obtained with some frequency converters. For PTS, the necessary frequency is generated by some Stirling engines with the rotor and stator adequately winded. Where the value and the uniformity of the load allow obtaining speeds of 50 (in some countries 60) of piston thicknesses per second, the supplying can be obtained firm the network. High movement speeds can be reached if the thickness of a pole is small enough. In FIG. 10I, each pole, on the rotor and stator, is each made with a single spire; the rotor is supplied with direct current and the stator with alternative current, its polarity changing when a spire of the rotor comes in the axis of a spire of the stator.

At all the engines with spinning field the heads of the receiver are used for braking and, after stopping, for acceleration. Because this thing is more difficult to obtain by the adequate modification of the frequency, in these areas we can proceed to an adequate winding of another type of inline engine, preferably one of alternative current, and the supply of the coils in the end of the receiver is done from a different circuit. We can also notice that at the mono-phase synchronous engines there are no longer necessary the devices used for creating the torque starting, because the switch to the supplying in alternative currents occurs during the functioning.

Following the same principle, we can build receivers driven by linear special synchronous engines: engines with field modulation (Schmidt-Lorentz), engines with pulsating field (Guy), engines with interference, where the piston is not winded, but it is made of ferromagnetic materials and its ends are provided with the necessary slots.

7. The receiver with linear generator. All the engines described in the previous paragraph are reversible: when the piston moves due to the difference of pressure of its surfaces, and the stator is supplied with electric current, in the rotor a current that generates a power equal to that which moves the piston is induced. At some generator types, the rotor can be inductor and the stator inducted. At PTS, both the receivers of the force of Sterling engines and the cylinders of the pneumatic engines are reeled as generators. We have to mention that due to the alternative movement of the piston, the current generated by a single receiver cannot have constant parameters. These parameters can be obtained through the correlation of the functioning of more identical receivers (at least two for direct and mono-phase current, and at least four for alternative current), thus when a piston comes out of the acceleration area another piston enters the braking area, the number of active pistons being always constant.

8. Double-gamma Stirling engine. PTS uses a type of engines named double-gamma for moving some mobile elements of the engine and also for producing electric energy; double-gamma comes from the fact that it is built by putting head to head two Stirling gamma engines, displaced with 180 degrees. The power of such an engine equals the power of two gamma-engines, running separately. The engine is composed of a 12a warm receiver (not necessary with the cylindrical section), placed in a combustion chamber with insulated walls (or in a heat exchanger, heated by an unconventional source, in a condenser with refrigerant of a heat pump, in a source of geothermal water, in a solar barrier, etc.), a 12b cold receiver and a 12c power receiver (featuring any section), that are placed in the atmosphere or are submerged in a cooling basin (or in a cooling receiver, in a vaporizer, in an enclosure that has to be heated, in a solar barrier oriented towards north, in soil, in river, lake or sea water, etc.). Each of the heads of the receiver engine can be attached to the system before and after the adequate recuperator, depending on the temperature we want to work at.

We have to mention the followings:
the solution with the most intense pressure fall on the piston is that with one warm head (12s and 12t pipes) and a cold head, but this shows the biggest heat losses: on one hand, there is a heat exchange between the two chambers, through the piston and through the walls; on the other hand, there is a heat exchange between both chambers and the environment where the receiver is, environment with a certain temperature, adequate to the heat exchange with one chamber, but totally inadequate for the other. The best placing solution in this case is to fit the warm head in the warm environment and the cold head in the cold environment.
the solution with two cold heads or two warm heads (12s and 12v or 12u and 12t pipes) eliminates the heat exchange through thermal transfer with the environment and the isothermal exchange is made equally in both directions: what is eliminated through compression is gained through expansion; in exchange, both the cold and the warm air, introduced after they pass through the recuperator, decrease the pressure fall on the surfaces of the piston, so much more the ratio between the volume of the receiver engine and of the movement receiver is bigger.

We chose here a version with both cold heads, in which the receiver can function like a heat pump: in the expansion phase from the receiver engine, the temperature of the gas decreases to a point bellow the temperature of the T0 environment and receives a heat supply from the cold source. The receiver can be provided with 13d double walls and with 13g additional insulation. This way, the heat that is evacuated during the compression, instead of being eliminated in the environment, is returned to the system. If the walls are provided with a 13f circular piston, with a movement simultaneous to the movement of the engine piston, on one side of the piston it is allowed a fluid from the environment that washes the walls of the compartment where the compression takes place, taking over the evacuated heat and introducing it in the system in a heat exchanger, and on the other side of the piston it is allowed a fluid from the environment that washes the walls of the compartment where the expansion takes place, delivering heat, then being repressed back in the environment or used for cooling. In the figure it was chosen the solution in which, between the two chambers of the double walls, a 13h recuperator was fitted, transforming the receiver in a heat pump.

The schematic and the functioning circuit is presented in FIG. 12, with a P-V diagram of the main circuit. The moment 1 corresponds to the expansion-compression phase (curve 1-2 in diagram P-V in FIG. 12): the valves 12g, 12r and 12j open, and the warm air from the 12a receiver expansions isothermally at temperature T1, from p4 pressure to p3 pressure and reaches the receiver engine 12c, delivering heat to the 12f recuperator and pushing on a side of the 12h piston, simultaneously with the isothermal compression of the cold air in the 12b receiver and of the one from the other side of the 12h piston, at temperature T0, from pressure p1 to pressure p2, accumulating in the cold receiver. During this phase, the 12h piston runs a complete half-stroke, moment when the movement pistons 12d and 12e remain at their extreme positions. Moment 2 corresponds to the movement phase (curve 2-3): valves 12g close and the four valves of the cold and warm receivers open, both movement pistons move simultaneously, from one end to the other of the cylinder, the air from the warm receiver passes through the recuperator, where it delivers the remained heat, until the T0 temperature in an isochoric cooling, its pressure decreases from p3 to p1, and the cold air, with p2 pressure, is pushed from the cold receiver through the recuperator, where it warms up to the T1 temperature and enters the warm receiver with the p4 pressure. Moment 3 (curve 3-4) takes place with the 12g, 12p and 12q valves being open and it is a compression of the air from the cold receiver from p1 to p2 on the T0 isotherm, in the same time with an expansion of the air from the warm receiver, from p4 at p3, on the T1 isotherm, and the moment 4 (curve 4-1) is a movement of the air between the two receivers, the valves of the receiver engine being closed.

The volumes of the receivers are calculated in such a manner that during an expansion-compression phase, the engine piston should use all the available energy, so that at the end of this phase, the pressure should be the same in the entire system, and this happens only if the p2 and p3 pressures are equal. To keep this characteristic of the system in all conditions, at the end of each half-stroke, the pressures of both sides of the engine piston become equal, either by using a valve fitted on a pipe connecting the heads of the receiver or by providing its walls, at both heads, with a 12n channel, having a length slightly longer than the thickness of the piston. This way, when the piston reaches the end of the stroke, the gas from the chamber with higher pressure passes through this channel to the next chamber, making the pressures equal. This method is extremely useful as it allows an adjustment of the power of the engine depending on the charge: a variation of this charge is reflected in the decrease of the rotative speed of the engine, that can be immediately noticed by a speed transducer and can be converted in an increase of the fuel flow or thermal agent inside the wall receiver, which leads to the increase of the temperature in the warm receiver (curve 2-5 in the diagram).

As a result, the expansion of the gas takes place after the T2 isotherm (curve 5-10), to the maximum volume of the receiver engine, to a pressure higher than pressure p2. In this moment, the 12n channel opens and, the engine agent continues its expansion in the cold receiver (curve 10-6), compressing the gas that could be found here (curve 1-8) till the moment of establishing a p6 balance value also higher than p2. After the cooling phase in the recuperator, the gas reaches the T0 temperature and a p5 pressure, lower than the initial p1 pressure and the cold gas, warming up to T2, increases its pressure from p6 to p8 (curve 8-9). After that, the cycle follows the closed 9-6-7-8 curve, delivering more power to the consumer, till the top of the charge disappears. If the heat supply comes back to the initial conditions, the temperature of the warm gas comes back to the T1 value and the expansion ends at p2 pressure, before the piston reaches the end of the stroke. The movement of the piston continues till the end due to its inertia and it reaches the equalizing channel: now, the cold gas from the cold receiver, having a higher pressure, expands, a part of it enters the power receiver and compresses the warm gas and the system comes back, after several cycles, to the initial parameters. For a good functioning of the receiver in these conditions, it is necessary that the two recuperators to be adjusted for the maximum temperature reachable by the system. As a result, in rating the heat exchange from the receivers takes place in one of its central areas, the peripheral areas do not contribute to the thermal exchange.

The existence of the 12n channel (or of the valve) ensures the self-adjustment of the system even when the temperature of the cold source is not constant. More than that, such a system is auto-reversible, keeping on functioning, without outside interferences, even if in certain periods of time, the warm source cools down bellow the temperature level of the cold source (it is the case of the engines functioning on the difference of temperature between air-soil, air-water, etc.): for example, considering the receiver described in FIG. 10A, at the decrease of the temperature of the warm source, the self-adjustment leads to the decrease of the pressure difference between the two sides of the piston, till the piston won't have the power to compress the braking spring and it will stop. The spring doesn't allow the piston to stop in the dead center (for other receivers, in the area of the dead center electrical switches are fitted to supply the induced circuit till the piston leaves this area; when the pressures are equalized with an electro-valve, on its supplying circuit a switch of a pressostate is fitted, in order to turn it off in case of too low pressure differences, etc.) so that at a high enough temperature difference, regardless of its direction, a pressure difference occurs sufficient to restart the system.

Practically, the movement of the pistons is continuous. In current practice, the movement is usually ensured by a rod-crank mechanism that has the disadvantage of overlapping the end of a phase with the beginning of the next one, which leads to serious distortions of the cycle shown in the P-V diagram, with the decrease of the efficiency of the equipment. Such systems can be also applied to the double-gamma engine, but at the PTS, where the temperatures are lower and higher efficiencies are required, a different system is applied: during expansion-compression, the displacer pistons reaching the end of the stroke are stopped or have a very slow motion. To this effect, one or several pairs of receivers running with the same cylinder are added to the system. The number of additional receivers depends on the functioning gas and on the speed of the engine piston. To obtain the highest efficiency, it's necessary that the heat exchanges in the recuperator to take place as completely as possible, and this requires a shorter time (for hydrogen, helium) or longer time (for air, nitrogen, CO2), depending on the functioning gas and the constructive characteristics. By dividing this duration of time to the duration of a complete stroke of the engine piston, we can determine the optimal number of receiver pairs that need to be added. We have to emphasize that at an even number of pairs of receivers, each of these have to run every time on other side of the active piston, thing that requires connecting pipes and additional valves and creates large dead volumes. This is why the PTS uses, for helium, a number of six transfer receivers (as in FIG. 12), and for stronger powers, the number of movement receivers is even more increased and the speed of the engine piston is also increased (for the same volume of the receiver, the section is increased and the length is decreased, the strokes being shorter and more frequent). For air, instead of recuperators heat exchangers in counter current are used, at constant volume (as in FIG. 3). In FIG. 12, at the initial receivers (system A) there have been added another two systems (B and C) each one of them featuring the same elements, connected in the same way as at system A, the connection with it being made with a distributor placed at the entry and at the exit of the engine receiver. The power of such an engine is higher than the power of six gamma engines, with movement receivers identical as volume and piston speed. The movement of the system as a whole is dictated by the engine piston, which has an alternative, continuous and uniform motion, converted even in the spinning with constant rotative speed of a flywheel actuated by a rod-crank, by a strand roller chain, by adherent wheels, or even in generating an electrical power with constant parameters. In both cases there is a reacting force which levels the movement of the piston. In case of a mechanical coupling, a part of the energy of the flywheel (so of the receiver), is taken over by a transmission system, that sends commands to the other elements of the system, depending on the position of the engine piston. The energy taken over by the transmission system is weak enough and it is destined to overcome the frictions, because the pressures in the movement receivers reach the same level. The transmission of the movement can be acquired by any of the classical systems, for example by a camshaft that makes a complete rotation during 3 strokes of the piston. If we grade the movement of the pistons on a scale from 0 to 10, we consider the engine receiver being the D system, and we allocate the “c” index to the warm receivers and the “r” index to the cold receivers in the 3 systems A, B and C, the cams will have such positions as to ensure the following phase sequence:
1. open: valves 12g; D=0-10; Ac=10, Ad=0; Bc=5-0, Br=5-10; Cc=0-5, Cr=10-5
2. open: 12i; D=10-0; Ac=10-5, Ad=0-5; Bc=0, Br=10; Cc=5-10, Cr=5-0
3. open: 12k; D=0-10; Ac=5-0, Ad=5-10; Bc=0-5, Br=10-5; Cc=10, Cr=0
4. open: 12g; D=10-0; Ac=0, Ad=10; Br=5-0; Cc=10-5, Cr=0-5
5. open: 12i; D=0-10; Ac=0-5, Ad=10-5; Bc=10, Br=0; Cc=5-0, Cr=5-10
6. open: 12k; D=10-0; Ac=5-10, Ad=5-0; Bc=10-5, Br=0-5; Cc=0, Cr=10

At each end of a half-stroke of the engine piston, the camshaft commands the closing and the opening of the correspondant valves.

In the case of an electrical transmission, it is necessary a permanent feed-back between the position of the main piston (generator of electrical power) and the position of the auxiliary pistons (inline engines). This is ensured by fitting some position transducers on each receiver.

In comparison with the other engines functioning after the Stirling cycle, the double-gamma engines feature many advantages:
they are more compact—as a result of the use of a single power piston at more movement pistons, and at the receivers with generator and with inline engine, the system rod-crank and the flywheel, extremely large, are missing.
the cold cylinder and the warm cylinder are completely separated and they can be placed in different chambers with different temperatures.
they run completely each one of the four phases of the ideal cycle that leads to an important increase of the efficiency.
in case of using inline engines for moving the motion pistons and a linear generator for exhausting the power, the sealing issues are completely eliminated.
they allow the adjustment of the power depending on the charge variations.
they are reversible regarding the cold and warm source.

9. The Stirling compressor is a Stirling engine at which a part of the produced work is used for compressing the gas. As we can see in FIG. 15, the compressor is composed of the two receivers 14a and 14b and the two recuperators 14c, and the power receiver is replaced by two pneumatic engines 14e and 14f. The warm air in the receiver 14a is used in the first phase for compressing the cold air in a tank or in a cold receiver 14d. Because there is a pressure difference between the two receivers, this difference is used to produce work in the 14e engine: the warm air expands isothermal in the 14e engine (curve 2-5 in diagram PV), with discharge in the 14d cold receiver, where an isothermal compression takes place till the pressures are equalized (p5). The isothermal expansion continues through the 14f engine in the 14g atmosphere (curve 5-3), in a tank or in the 1b receiver. Next we have the motion phase of the movement pistons: the warm air, with T1 temperature, reaching the pressure of the atmosphere, passes through the recuperator, cooling at constant volume till the T0 temperature and the p1 pressure (curve 3-4), and the cold air, with T0 and p1 pressure passing through the recuperator, warms up at constant volume till the T2 temperature and the p4 pressure (curve 1-2). In this moment, an admission valve opens and atmospheric air enters the 14f engine (if the functioning gas is not air, it is in a tank with p2 pressure), which produces work, then isothermally compresses the gas in the cold receiver to the p2 pressure.

The cycle begins again identically (if after the discharge in the 14d receiver, also took place a discharge in the 14b cold receiver, the cycle starts over with a higher pressure than p4 in the 14a warm receiver), producing work and recompressing the gas in the 14d cold receiver. The 14d receiver is the cold receiver of an identical Stirling engine, being the second step of the compressor. In the second step, the diagram of the cycle follows the 7-3-4-6 curve and results in producing more work, introducing more heat in the system, introducing more additional gas and obtaining a higher pressure for the second step of the compressor. The use of more steps leads to a progressive increase of the produced work and of the evacuating pressure from the compressor. The last step can be a Stirling engine, a tank or a caged turbine.

10. The compressor with atomizer is a compressor as found in the current technical stage, a Stirling compressor or engine, a heat exchanger at constant volume, etc. whose functioning characteristic is corrected by atomization of a liquid gas (usually the working gas) under pressure, gas that has the vaporizing temperature smaller than the temperature of the environment in which is introduced. The liquid drops spread in the working gas are instantaneously evaporating, cooling the gas and increasing the pressure in the working chamber. This way the curve describing the working process can be modified with positive effects. For example, atomizing liquid working gas in a classic compressor leads to the decrease of its temperature, so that the process can become isotherm or even sub-isotherm. The expansion of the additional gas inside the compressor produces an important mechanical work which easies the load of the powering engine reducing the consumption of electrical energy and recovering the biggest part of the energy used for compression and liquefaction of the gas. The material spending is also reduced by eliminating the heat exchangers between different compression stages, while the materials used for manufacturing the walls, the piston and fittings are cheaper. It is indicated that the liquid is atomized using a small pump to increase its pressure, so that the atomization is as fine as possible and the expansion as strong as possible. As well, the temperature of the atomized liquid has to be as close as possible to the temperature of the receiver in the moment when introduced, so that there is no need to cool it.

Applying the procedure in fridge installations (FIG. 15) by taking a quantity of liquid from the exit of the condenser 15a and atomizing it with the atomizer 15e in the compressor 15d immediately after the liquefaction temperature is reached makes the whole process an isotherm one (curve 3-4 in the diagram), so that the supra-compression and cooling under constant pressure is not anymore needed which leads to a significant improvement of the process with important energy savings. It's advisable that the thermal agent from the exit of the compressor is cooled and the atomized liquid is taken from intermediate places from the cooling exchanger or even from its exit. In the lack of an exchanger the liquid can be taken from the entry into the vaporizer, but in this case the atomizer pump is a must. Moreover, the adiabatic compression process using a compressor can be completely replaced with a process of heating in constant volume and adjusting via atomization, so that the process is happening on the saturation curve or on an adiabatic curve, followed by isotherm compression. This process happens in another element of PTS, the compressor under constant volume.

Same corrective process can be applied to other systems, for example to the internal combustion engines. The atomization can also be reversely used to modify the expansion processes by atomizing a gas with the liquefaction temperature higher than the one of the environment into which is introduced. By liquefaction of the atomized gas there is an evolution of heat that can transform the expansion process in the turbine or in the pneumatic engine into an isotherm process.

11. Compressor with liquid. PTS is using different liquids with good thermal transfer coefficient for the heat transfer from the non-conventional source towards the receivers, for heat transfer between its different elements, as well as for heat transfer from the system to the storage tank and vice versa. The liquids used are moved using liquid pumps or Stirling fluidin. In order to achieve a constructive simplification of the system these pumps can be also used for moving some of the pistons in the system: displacer pistons or pressure pistons (for example for filling in the receivers in the isobar-isochoric compressor at constant pressure). The power transfer is made using double effect pistons, similar to the ones in FIG. 5a. One of the two cylinders becomes part of the liquid circuit, aspiration being done alternatively on both faces of the piston somewhere on the pipe path, increasing the hydraulic resistance to be overcome hence needing an incremental power of the engine. The other double effect cylinder becomes part of a gas circuit, being either the moving element or providing pressurized gas to more tanks from which each independent circuit extracts the needed power. In FIG. 5A the driving wheels 5c and 5d are only needed if there is an excess of energy in the power of pump engine that we want to recover. While the length of the two cylinders needs to be equal, the diameter of the gas cylinder and its piston can be different vs. the diameter of the liquid cylinder: if the gas cylinder diameter is higher there is a movement of a higher gas quantity at low pressure, while if the diameter is smaller the pressures reached are high and the quantity of gas used is smaller. Using the compressor with liquid requires the corresponding power increase, but this is realized on an existing element and occupies a smaller volume than a compressor with gas with the same power.

12. The compressor with refrigerant brings additional power in the system based on the heat absorbed from the environment by refrigerant evaporation from a tank placed in an environment with the temperature as high as possible (reached with focusing mirrors). If the working agent is the respective refrigerant, by injecting it in liquid state into an environment with a lower pressure, it vaporizes absorbing heat from the environment and cooling it but increasing its pressure; if it is injected in a gas state it increases both the temperature and the pressure of the respective environment. The excess of agent is liquefied in the same time with the main agent, being recovered and re-introduce into the tank. If the working agent is different, the refrigerant is used for expansion in a pneumatic engine with the same construction as for the compressor with liquid. The mechanical work produced is used in a similar way (especially for cooling the agent in the cold receivers of isochoric-isobar compressors at a constant pressure). The expansion is done in one or more steps until the liquefaction temperature is reached, then the agent is introduced in a condenser where a part of the cumulated heat is recovered and it reaches the tank helped by a pump. Special attention has to be paid to the agents that have the critical point close to the range of 0-100 Celsius degrees (for example CO2 which has the critical point at 31 degrees and the critical pressure at 7.4 MPa), gases that need a small quantity of heat for vaporization and which can develop a significant mechanical work with a small heat quantity used for overheating.

13. Isochoric-isobar compressor (FIG. 19) is built from a succession of warm receivers 19a placed in the warm source alternating with cold receivers 19b placed in the cold source. The atmospheric air (or the gas from the exit of a turbine) enters the first cold receiver (with no mechanical work consumption) where it cools at a constant pressure: as the air is cooled, additional air enters the receiver. Then the air is transferred into the first warm receiver where it is warmed at a constant volume, reaching the temperature of the warm source and the corresponding pressure (p1). By a simultaneous movement of pistons the warm air is moved into the cold receiver, where it is cooled under constant pressure until it reaches the temperature of the cold source, by opening the communication with the atmosphere. Then the gas is transferred again into a warm receiver and re-heated up to temperature T1, its pressure increasing up to p2. The process continues using additional air from the atmosphere and consuming mechanical work at each pressure stage, a mechanical work sourced from a corresponding number of compressors with liquid, with refrigerant or Stirling compressors. When the working pressure is reached, the air is stored into a tank or is provided to a caged turbine.

The speed of the compressor can increase considerably if counter current heat recuperators or heat exchangers are introduced between the cold and the warm receivers. In this way once the heat is absorbed it is kept into the system and it's not released to the cold source. It's also possible to realize a series of combinations with a Stirling compressor with the same number of steps in order to use the heat for producing mechanical work.

14. The compressor under constant volume is a receiver with atomizer. It takes the role of the compressor in the installations with reverted cycles. Similarly to the compressor, it is linked between the vaporizer's exit and condenser's entry and placed in an environment with the temperature equal or higher than the compressor's. Piston movement is done maintaining constant pressures on both sides of the piston (the condenser has a higher capacity than in the installations with classical compressor because of that). When the piston reached the end of the path and the receiver is filled with vapors, the admission valve is closing and the vapors from the condenser are taken by the second receiver, then by the next one. The number of the receivers has to be enough to cover the time frame needed for the adiabatic-isotherm compression in the first receiver. This is the moment when the atomization of the agent liquid collected from the condenser exist starts. The quantity of the atomized agent is controlled and done such that in the first stage the heat quantity absorbed through evaporation is equal to the heat quantity absorbed from the environment (the agent's temperature will only increase during the compression) so that the evolution of the gas parameters is close to the evolution of adiabatic compression. If this phase happens inside a receiver with double walls, between the walls a liquid can be cooled (the water for a cooling installation, the liquid agent before being introduced in expander. From the moment the condensing temperature has been reached, the quantity of atomized liquid is decreased so that the temperature caused by compression can be evicted outside and the temperature of the agent remains constant. In this phase the liquid agent is introduced using a pump to increase its pressure to a higher value than the one in the receiver. The process continues until the vapors reach a saturated state, when a new ride of the piston can start. All the time during the compression the continuity of the cycle has been ensured by other receivers that continued to take the vapors of the agent. In this moment both valves are opening and the piston movement happens in reversed direction (with the corresponding mechanical work consumption). The vapors are introduced in the condenser and a new quantity of vapors from the vaporizer enters the receiver. These movements can be executed simply through valves, with no additional consumption of mechanical work based on the expansion of the liquid in the expander. As can be seen, the fluid movement is done solely based on heat exchanges, the only mechanical work consumer being the atomizer pump, but even this one can be powered by a Stirling engine whose warm receiver takes the heat from the condenser and gives part of it to the vaporizer, based on the increased quantity of the agent moved and absorbed heat. At the condenser exit a part of the liquid agent is directed to the expander, the other to the compressor with constant volume. If the compressor is part of a cooling installation it can even take a part of the needed heat from the heat evolved by the condenser. If the installation is a heat pump, it needs an incremental heat from a source with a temperature at least as high as the condensing temperature (for PTS focusing and thermo-resistant mirrors are used) in order to become warmer than the environment, but the energy released by the condenser is much higher.

15. The Receiver with thermo-resistances is a receiver having thermo-resistances placed inside its walls for heating the air inside. The resistances are powered by the currents produced by the receivers in the breaking regime and by the engines and turbines whose produced power is too small to be introduced in the network. As well, they are useful to ensure the continuity of system's functioning in the lack of the non-conventional source (for example in some of the cloudy periods) when they are powered from the electrical network.

16. Caged turbine is a turbine which can function hydraulic as well as with steam or with gas, characterized through a particular disposal of rotor blades and of nozzles of stator, that can be used for the conversion of hydraulic, pneumatic and thermal energy from conventional sources and specially non-conventional ones, in mechanical power and especially in the area of small powers. The turbines in the current stage of development do not have too many applications in where low and very low powers are required and their efficiency in this type of application is quite reduced. Because in those turbines the surface of the blades where the process of transforming the kinetics energy of the motive agent into mechanical energy of rotor rotation is relatively small, the motive agent (water, steam or gas) has usually high temperature and pressure and for obtaining some acceptable efficiency requires big rotation speed of rotor. A bigger surface have the blades of the last stages of multi staged turbine or of the turbine blades Ljungstrom like, but the length of those blades is limited by the fact that their setup on the stump is made at one end only. The caged turbine as it is described in this invention solves the problem of enlarging the active surfaces, by using rotor and stator longitudinal blades, fixed at both ends on ring-shaped rims, The blades are disposed in a radial, diagonal, radial-axial, radial-diagonal, or diagonal-axial configuration, cage like. This way the surface of a blade can be enlarged through increasing its length, especially if intermediate support points are added. In this way the motive forces obtained on each stage are as high as for the usual turbines by processing specific lower enthalpy falls of larger volumes of fluids, which can generate comparable performances with the classic turbine, at lower pressures, temperatures and rotations. In these conditions the caged turbine becomes capable to work specifics falls of small enthalpy contained in different residual sources or non-conventional energy sources like the gas resulted in some technological processes, solar energy, geothermal energy, etc, which gives them a big advantage versus the turbines in the present stage of technical development. The blades channels made in this way are bordered on four sides and space between rotor blades and the stator blades is limited on both sides by the rolling elements of the rotor, sealing problems being easier to be solved. The placement in cage of the blades allows the manufacturing of all types of turbines known in actual stage of technical development: with action and reaction, mono and multiple staged, centrifugal and centripetal, Ljungstrom like, in condensation, with counter pressure with horizontal or vertical axis, etc, and even of new types of turbines, for example: reversible turbines, reaction turbines, turbines with ejection, turbines with compression stages. Also, caged turbine can function through supply with compressed air as a pneumatic engine. Centrifugal compressors radial only or diagonal with caged rotor without ante-rotor, where the air intake is done through a chamber in the turbine axis with or without directive blades can be also made.

Moreover, this way of placing the rotor and stator blades allows the setup on these blades of some electrical conductors, permanents magnets, electromagnets and magnetic ladle-shank, the location on the crown of one or more collectors and also the usage of soft or tough ferromagnetic materials when manufacturing rotor and stator blades, obtaining this way one or more electric generators embedded in the turbine, and also by removing classical mechanical coupling, gaining in volume and flexibility. This way all types of electrical generators can be manufactured: of direct current, in series and derivation, mono-phased, tri-phased, poly-phased, synchronous and asynchronous, with single and hetero polar field with hysterezis, with field modulation, with pulsating field, with interference.

Even for applications which are using a classical turbine, using a caged turbine introduces lots of advantages:
A more compact solution, the caged construction leads to the replacement of rotor discs (respectively of brake drum into reaction turbines) with pairs of crowns with smaller sizes.
A higher length, which allows obtaining higher powers at smaller diameters of the turbine, very important element in some applications (like aeronautics)
Making electric power generators embedded in the turbine
Having closed blade channels allows an easy regulation, as well as the set up of switching off elements and of one way valve in any stage of the turbine, allowing this way the conservation of a special type of pressure regime in the turbine stages and in the condenser, after the turbine stop
Because of the way the stator and rotor blades are constructed and disposed they can be crossed by channels accessible through both ends and circulating a thermal agent, with the objective to realize a heat exchange with the primary agent with positive or negative gradient, changing this way functioning characteristics of the turbine through re-overheating, regenerative pre-heating, cooling, etc, in order to obtain a cycle close to Carnot or Ericson cycle. The thermal agent circulating inside the blades can be even the primary agent, and when the blades communicate with the interblade space effects of ejection in stator and rotor and effects of reaction in rotor, as well as changing the functioning cycle, through positive or negative variations of debit, pressure, or temperature in every point from functioning curve can be realized and through this speed changing and adjustment of the mechanical load.
Because the admission of primary agent is usually made through the central area (area which for classical turbines is occupied by rotor disks or by bumper) and because obtaining a minimal power in first stage requires the corresponding diameter, there is a free space the results along the turbine axis which allows the disposal of some of the component elements of the system (burners, supra-heaters, regenerative pre heaters, intake pipes, vane, regulation elements, re-intake pipes, exhaustion pipes, compressors with blades and ejection, electric generator). Other elements of the turbine can be located in the blades and inter-blades space resulting in an extremely compact construction. For the condensation turbines, the case can become a condenser.
This type of turbine is extremely flexible, can be sized for very small or very big capacity, for all type of temperatures and pressures used in present stadium of technique, for a large range of rotation speeds including a very small one. In the multiple stage turbines, through appropriate manufacturing of the profiles and dimensions of rotor and stator blades, there is a wider range of possibilities to split the entry enthalpy between stages (inclusively through introduction of primary agent in and between certain stages), there is the possibility to introduce some sectors of compression stages between the active stages, the possibility to make multi-isothermal stages, possibility of different rotation speed for different rotor stages, inclusively making of rotors with different rotation directions.
   It is more economical for the same parameters of motive agent, so that by manufacturing all types of losses that decrease the efficiency of current turbines can be reduced, and through the propagation of the energy transferred by the thermal agent from the center of turbine to exterior, the temperature of the case can be limited more efficiently; all energy stays inside, different types of losses, including the friction and electrical ones are transformed, in the last instance useful energy. By increasing the diameter and the length of case, the exit pressure of the thermal agent is easier to be reduced, and introducing in the space between the case and the last stage of a heat recuperator, allows and reduces the exit temperature. The caged turbine is much more fit than other turbines for binary regime.
   It is much easier to start and adjust, and is acting much better at load variations, can work with a wider range of working agents. Due to the many advantages mentioned, the caged turbines can replace the classical turbines in the majority of their applications, especially into the energetic ones, they can complete the already existing installations increasing their performance or can improve the current turbines by applying only some of the constructive elements of the caged turbine. They constitute the main power element of PTS.

The disadvantages of this kind of turbine compared to the classic one derive also from its constructive particularities: the length of the blades lead to the appearance of some centrifugal forces in the rotor, the higher the speed rotation of the engine, the higher the forces. Reducing those forces can be done by introducing along the blades intermediate crowns supported by additional bearings. These bearings are nevertheless the less reliable elements, especially at high temperatures of thermal agent and are the hard to reach in case of damage. Their safe functioning, imposes the existence of a performing lubrication and cooling system, or manufacturing of some special sliding bearings, with oil film at high pressure, with air pillow, or with magnetic pillow.

The most simple type of cage turbine (FIG. 21A) is composed from a rotor (21b) with radial blades, set up through a ball bearing (21i) on an exhaustion pipe of a pneumatic (21e) or hydraulic thermal installation (this one being the stator of turbine), for using its residual power and transforming it in mechanical energy available in the rotor axis. This type of turbine has a quite a low efficiency, but it is simple and cheep and can use an energy that otherwise would be lost. Starting from this type of turbine by adding new components, classical or specific to the cage type of construction, the performances obtained are increasing and increasingly complex applications become available. At the turbine if FIG. 21A, the superior performances are obtained setting up a stator in the pipe prolongation (FIG. 21a), made of many nozzles or stator blades. In an even better phase, on the stator one or more of following components is set up: additional stator-rotor stages, regulation elements, the embedded electrical generator, starting engine, rolling elements, case, elements of intermediate admission, combustion rooms, combustion rooms with piston, centrifugal compressor, oil installation, admission pipes, etc. The selection of the elements which will be part of the turbine is made by the needed power and the type of application. We will describe most of those component elements, illustrated by the manufacturing of the simplest type of turbine, the radial centrifugal mono-staged turbine (FIG. 21) and of the bi-rotor caged turbine (FIG. 23), while the other elements being presented in the same time with the turbine they are specific to.

The stator: (FIG. 21a, FIG. 22) consists of a series of identical blades, having an equal distance between them (FIG. 21a, FIG. 22b, FIG. 23a) and-each having each end fixed to crown (21e,22a,23e). For bigger lengths of the stator and high rotation speeds or from reasons of making the electrical generator (for making magnetic circuits with small reluctance), the stator can be made from more blades assembled head to head, with intermediary crowns (22C). The stator crowns have the shape of a ring or a disc and are placed in parallel plans, perpendicular on the rolling axis, and can have different diameters (22B, C). The blades can be straight, their axis being parallel with turbine axis (22A, cylindrical blades), or make a certain angle with it (22B, C, conical blades), convex curved (22D), or concave (22T), semispherical (22E), arc sector (22F) etc, and the transversal section of the blade can be constant (22A, D, F) or variable (22B,C, E). The shape and the size of this section is depending on the working agent, its pressure and temperature, and is computed same as for the radial classical turbines but also considering and the specifics of distribution in cage and of the other component elements like electrical generator. Especially for small powers, hence at small speed of thermal agent draining, the shape of the blades is significantly different versus the classical shapes, because at these speeds the friction losses are much smaller, and the simplicity of the construction becomes the priority. Fixing the blades on the crown can made through casting, followed by a mechanical processing, through soldering, or with assembly elements (rivet less, screws, etc)

The easiest stator is manufactured from an empty cylinder, with these walls, metallic, from plastic material, or from other material which can resist in the working conditions (FIG. 21a). At one of the ends the cylinder is closed (21d), and at the other end it has a coupling element (21e). The nozzles are made by creating slots in the cylinder walls, throughout the length of generators, leaving the ends full. The slots can be longitudinal (21f) or helicoidally (22.P). If the cylinder is sectioned in one or more plans which are crossing its axis (22Q), one can obtain one or more cylindrical sectors, in which the slots can be executed working on the walls from inwards, resulting in some nozzles with constant section (22.G) or variable (22.H, 22.J, 22.I: convergent nozzles). Acting on the external walls, one can ensure the divergent shape of the exit of the nozzle (22.J, 22I). And because of easing the exploitation, especially in multi stage turbines, it is preferred that the stator is being manufactured from two or three segments which are assembled after blades assembly. As well, the execution of the crown form several segments allows that between those segments a series of adjustable articulations are introduced, and acting upon them one can easily extend or a decrease the crown diameter, even during its functioning. For the very long stators the slots are stopped from place to place (22Q), to minimize the radial deformations due to the speed of rotation. The lamellas which are built between those slots are the stator blades. If the width of the blade is bigger than the thickness of the cylinder wall, these lamellas can be used as supports for nozzles assembly (22.M, 22.N, 22.O). For even wider blades, two cylinders with different diameters can be used, each being processed in an adequate way to make two supports for the nozzle made of iron plate (22.Y).

Another way of manufacturing the stator consist of separate processing of those two crowns, and the blades, followed by the assembly of the components. The blades can have different types of sections: trapezoidal (22.G), triangular or circle sector (22.H), rhomboidal (22I), circular (22L), elliptical, structional (22.J, 22.K, 23e), etc. Also the stator blades can be obtained from curved plate, and/or forged until it reaches the wanted profile (22d), and their attachment to the crown, directly, or helped by lamellas with simpler shape (22c,23l), fixed between the crowns. The attachment can be done through soldering, through casting, through assembling in slots cut at the periphery of the lateral disks (22.T, 22.V), or through some full rods or end rods (22.X), which are introduced in some holes made in these disks (22.R, 22.S, 22.U). The blades made from plates are reasonable both for the simplicity of their execution as well as because inside the inner gap can be introduced cooling fluids, oil pipes, electrical cables, etc, as well as thermal agent, with the wanted temperature and pressure, and through an extra nozzle (22e), the working debit can be increased. If the pressure of the agent introduced in the stator blades is high enough and the exit channel is adequately shaped, one can make exhaustion valves on each blade, which by involving the agent in the inter-blade space leads to the improvement of the flow regime. As previously said, some or all blades can be manufactured as magnetic cores, full or from sheets, and around them a winding of electrical conductors is made, or ready made coils are setup. Also the profiles made by plate, allow manufacturing of some sliding profiles along the support (22.W), and by interlaying some articulations or inflatable elements between profile and support (22g) allow the regulation of the distance between rotor and stator, depending of dilatations or other reasons.

The ROTOR.(FIG. 21b, FIG. 22) is made the same as the stator, from two rings or lateral discs (rotor crowns; 21k), which are rotating on the stator through some rolling bearings (21i,23i) or sliding bearings, computed and set up so that they allow the compensation of axial dilatations. The component elements of the rotor and their manufacturing and assembly are identical to the stator. The difference is in the different profile of blades. Between of the two discs, on the rotor cylinder generators, are set up using the stretching elements (21j) the rotor blades (21l, 23l), which can be straight (21b) or wiggled (22S), and whose profile is usually computed according to the usual practices, but taking into account configuration particularities. The helicoidally stator nozzles, or the wiggles rotor blades are adopted in the case of small debits when the distance between nozzles is big, in order to homogenize the pressure on all of the blades and to avoid a dead point at start. On one of rings elements of mechanical coupling (21m) are setup, or of electrical coupling (the receiver and the brushes). The same as for the stator blades, they can be full (22S), or empty (22R), made of plate (22d), shaped around the stretching element (22c), and also the same, inside the empty profiles, working agent can be injected, which in this case also has a reactive effect (22Z). The long blades can be stiffened from place to place through setting up some stiffening rings, intermediate crowns, or even some intermediate bearings, which give the possibility to obtain unlimited lengths. At an equal number of blades in rotor and stator and for approximately equal medium sections, the working agent suffers an expansion through the simple movement from the axis towards the periphery of the turbine, so that expansion degrees big enough can be realized even the rotor channels are narrowed by increasing the blades number, so that the number of rotor blades can be higher than the number of stator blades (22W), especially for the multistage turbines, the optimal ratio, not necessary an integer number, being given by the debit and the pressure of the primary agent. If between the turbine blades (stator and rotor) and the thermal agent there is a heat exchange, the blades profile is made with a string (depth) as big as possible (22W), so that the agent path is as long as possible. Same solution is recommended in the case when the turbine embeds an electric generator, to fill in as much as possible the rotor space of the respective stage with ferromagnetic material.

At high rotation speed, especially for the multistage turbines, the transversal section of the rotor blades can be variable: bigger close to the crown and smaller towards the center, the blades being narrowed in the central side, can be gudgeon like, or can have a counter arrow towards the cylinder axis (FIG. 22T). Also, the rotor discs can be conical, can be wheals with spokes, or can get another advantageous shapes form the mechanical load point of view. The shape of the stator nozzle is modified in all these cases, so that the inter-space between rotor and stator is as small as possible. If the mechanical repartition of loadings is better, one can also build turbines in sphere cages, ovoid, or another rotation speed object, which changes the radial turbine in diagonal one or radial-diagonal.

Rolling elements (FIG. 26). The inner diameter of the rotor crowns is bigger than the outer diameter of the stator crown. In the inter-space thus created one can introduce a bronze ring graphited or a ball bearing (21i) which can ensure the rotor rolling around its axis. At high powers and/or temperatures, this rolling system is replaced by a slide bearing which spindle is the rotor crown. Both types of bearing must be sealed with lateral caps for stopping the thermal agent leaking. For big diameters of the turbine, this rolling system can be replaced by the system described system in FIG. 26.A and 26.B. The rotor drown (26a) is taped from inside with a layer of an adherent material (26b) or with an inflatable tier. It is supported by a set of minimum three ball bearing (26d), much smaller, fixed on the axis(26e), which has one of the ends fixed in the case (26B) or it is introduced (26A), in a place specially created at the peripheral of the stator crown (26f). The ball bearing can be also covered by an adherent layer (26c) or by a tier. The system with submerged supporting wheels is the most appropriate for the groups of intermediate rolling. This type of bearing allows a series of adjustments, through small movements of the support rolling balls or through the inflation of peripheral tiers. In FIG. 26 two types of possible sealing are presented: with sliding rings (26h), fixed both inside and outside and with labyrinth (26g).

The same as for the Ljungstrom, type of turbine, the caged turbine can be bi-rotor (FIG. 23). Through setting up bearings on the stator crowns as well, and through profiling the blades with a reaction coefficient as appropriate, the turbine will have two rotors, which are rolling with the same rotation speed but in opposite directions. The power of one of this turbine is double versus the power of a one rotor turbine, with the same size and same rotation speed. The exhaustion of this power can made same as for the Ljungstrom type of turbine, with a different shaft on each rotor, through a single shaft that takes both rotation moments using a mechanical system with gears (23 l, m), or with adherent wheels, or even easier using an electric generator with two rotors. At the system with adherent wheels, both on the circumference of the rotor crown, as well as on the circumference of gearing stator gears (which become a support for the entire rotor) a layer of adherent material is setup (which can be also an inflatable tier). This system, even if it has higher sealing issues, is very-advantageous, especially for small rotation speeds, where the oiling is much simpler, the settings and the later interventions are made much easier, and on top, through small axis movements or through inflation and de-inflation of the tiers, it offers some adjustment possibilities. The turbine which is presented in FIG. 23, has two rotors and an internal stator, with blades made of shaped plates and with a debit adjustment mechanism placed inside the stator blades (23g).

The turbine ease (21c, 23c), in generally serves, for the protection of the last rotor stage, and could be missing where this protection is not needed, or being manufactured with a series of holes (being mane from net, a grill or a cage), to ease the primary agent exhaustion after complete expansion, if the turbine works in open circuit. The case can be metallic, from a plastic material, or any other type of material which can ensure the necessary protection. It can be thermally insulated or not, depending on the temperature of the thermal agent, can be closed or open, depending on the type of turbine. The shape and size of the case is computed depending on the exit pressure of the agent and the volume of agent it has to contain. Beside the protection role, the case can be use for supporting of linkage pipes and the auxiliary installations, for driving thermal agent after it was expanded in the turbine, for thermal exchanging with environment, for supporting a heat exchanger, for supporting of some electrical windings or of some magnetic yokes, and if the thermal agent is made of vapors that need to condense after expansion, the case of caged turbine can play a condenser role.

Regulation elements (FIG. 24). As the caged turbines are usually working at quite small pressures of the primary agent and with quite high debit fluctuation it is important that one can act efficiently on the entry debit. The way of turbine manufacturing, allows easy embedding of multiple regulation systems both for entry debit as well as for the working debit.

An efficient procedure acting on the exit section as well as on the entry section of the nozzles is described in FIGS. 21 and 23. On the stator is setup an external sleeve (21g) or internal (24g) of debit adjustment, made like a cylinder with braking which can slide on the main cylinder around the, and which through rotation, using a mechanism (21h), is covering a larger area (24B) or a smaller area (24A) from the nozzles section. The sliding regulation method, can be also applied to the blades with more complex profiles: this blades are made of two sections, assembled on different crowns, which can slide one inside the other. By rolling one of the crowns around the central axis, even during the turbine functioning, the crossing section of the agent is growing (24C) or decreases (24D) depending of the needs. If between the stator and the sleeve one is introducing sealing elements, the closing device obtained is very easy to use. The rolling of the regulating device can be made manually or automatically operated, depending on temperature, pressure, etc.

Another possibility of debit regulation, as well as of dilatation compensation, is done with the usage of mobile blades, which can rotate around their own longitudinal, which crosses the crown holes (24a) in which are introduced, using some gears fixed on each blade, at one of the ends of closing rod (24b). These gears are in their turn geared by a central gear which is rotating around the central axis of the turbine (24c), directly (24E), or through another gear (24d), which is simultaneously rotating two close blades, in opposite directions (24F). At small working temperatures the gears can be replaced by adherent wheels taped with rubber (an inflatable tier can be also used), or other materials which have the needed level of adherence and elasticity (24F). This type of mechanism can be used for ease of operation with some closing elements. The rolling can be made manually or automatic, depending of different parameters, both at starting as well as during the functioning. The turbine in FIG. 23 has both stator blades and rotor made of plates (23n) shaped around some supports (23l), set up between the two crowns. The debit regulation sleeve (23g) is set up exactly inside of the stator blades. Another regulation method is presented in FIG. 22.W. The blade made from plate (22l), is no longer rigidly fixed on support (22n), but through one articulation or through inflatable elements (22g), fixed between the two components of the blade, so that the table profile can slide on the support in the opposite way. This type of system, also applicable to rotors blades, can be independently applied to each blade and also allows the regulation of the inter-blade space depending of dilatation, and if the turbine is also equipped as electrical power generator, it allows the minimization of air gap.

The rotor blades are more difficult to adjust, but an adjustment is possible through blades rotation, with a rotating mechanism based on gears or adherent wheels, and with an automated device (like a thermostat), fixed of one of the crowns. Also, the blades sliding on radial direction can be done on the rotor as well using some articulations or inflatable elements.

The embedded electrical generator (FIG. 25), is the most practical method of power exhaustion developed by this type of turbine, a perfect applicable method to any classical turbines. For small powers of the turbine, a synchronous generator can be made by fixing on the case, next to rotor crowns, of some magnetic yokes and some magnetic winded poles, visible or buried, attached to a mono, tri or poly-phased network, which constitutes the generator armature, and on one or more rotor crowns, of some permanent magnets, or some winded poles, supplied in direct current, which are the excitation. Similarly to a classic power generator, the armature role can be taken by the rotor and the inductor role by the stator. If the armature is equipped with a brush system and a collector that switches in the moment of passing through the neutrals axis of inductor poles, a direct current generator is obtained, which can be linked in series or in derivation.

In FIG. 21 a method of producing this kind of generator is presented. The inducted poles (21m), together with the electrical winding (21n) are setup on an internal circumferences from an end of the case, the clamp box (21o) being setup on the exterior side to connect to the receiving electrical network, and on rotor crown an equal number of rotors poles supplied with direct current using sliding contacts (21p) is setup. The magnetic circuit is closing (21q) radial through stator poles, air gap, rotor pales, and transversal through the rotor crown and through the case. The frequency of the current debited by this type of generator is proportional with the turbine rotation speed and with the number of poles pairs. For small rotation speeds, in order to reach industrial frequency a high number of poles are needed. For fixing a smaller number of poles, as well as in order to be able to work at any rotation speed (depending on the temperature and entry pressure of the working agent), connection to network is made with a frequency converter, process which also eliminates the starting maneuvers preceding the reaching of synchronism rotation speed. The generator being reversible, through supplying from network of the stator as well, it can acting as an engine, which can simplify the turbine start.

For a higher power of the turbine, the rotors blades are cut from place to place, being interlaid with additional rotors ferromagnetic crowns, even if additional support bearings are not setup. At multi staged turbine, this type of generators can be made on any of the stages, through fixing of rotors and stator ferromagnetic intermediate concentric crowns properly equipped. The setup of this intermediate generators is usually done on the last stages of turbine, area in which due to the big diameter there is enough space for thermal agent expansion, and the obstruction on small areas of passing ways of the thermal agent is less impact full, the number of blades on a stage is maxim, the agent temperature is lower and the generated power is higher due to the bigger diameter. For even higher powers, manufacturing of the generator only on rotor crowns involves growing the size of each element used to close the magnetic flux: the rotor crowns, the case and stator, that's why for producing the poles the rotor blades can be also used. FIG. 25 represents a detailed crown sector grouping three blades and a section through them. In the blades structure are interlaid from space to space, parts of magnetic cores with slots (25k) where the appropriate winding can be made. If this type of assembly is done on more stages, several series of electrical concentric generators, displayed axial along the turbine are resulting, and choosing in an appropriate way of connecting in serial or parallel, one can obtain the voltage characteristics and load behavior much easier. For example, by displacing with 120 of electrical degrees of the blades and of the coils for three mono-phased successive generators, one can obtain the three phases of a three-phased system. For a better efficiency of mechanical energy transformation in electrical energy, the air gap (distance between rotors blades and stator ones, respectively between the case and the last rotor stage) must be as small as possible. This involves transformations of blades shape (FIG. 25) by reducing both the entry angle of rotors blades (25i), as well as the exit angle of stator blades (25j), and also the widening of entering edge and the rear edge, which leads to lower efficiency for conversion the thermal agent enthalpy in mechanical energy. Also it is necessary to introduce some magnetic yokes (25m) for closing the passing way section of magnetic flux which can lead to changes of working fluid flow regime. This type of magnetic yokes are not necessary made from one piece but can be fractionated and equidistant displayed throughout the blades. The compromise between the two transformation efficiency is done case by case, depending on the turbine power and parameters of thermal agent. Another compromise solution is to enlarge the number of blades on a single stage, accompanied by reducing their section and the step between blades (25B). In this situations, the magnetic yoke inter blades, is shaped so that it contributes essentially at drain section modulation.

Because of constructive particularities, the caged turbine which has the blades dispersedly placed on crowns as the rotors notch of an electrical machine, is appropriate for construction of generators with modulation field and also of the generators with pulse field, especially if the generator is made between the case (on which the magnetic yokes are more easy to make) and the last rotor. This goes to the rotors winding elimination and also the corresponding brush system. Also at this type of generators, the change of the shape of the blades, and introducing additional magnetic yokes is needed. One method to eliminate these yokes it is by making uni-polar generators.

These constructive particularities are much better highlighted when manufacturing uni-polar generators. An example of this type of generator is the one from FIG. 25.C. The inner side of the case is clothed with ferromagnetic material and equipped with lots of polar pieces (25d), displayed on the internal cylinder generator, in the same number and the same length like stator blades. Their thickness and their width are dependant on the volume needed for the thermal agent expansion at the exit from the rotor. The magnetic uni-polar field is created by a series of coils supplied in electrical, direct current or alternative current, transversal setup at the ends of the case (25a), according to the current practice, around of the polar pieces of the case, on all their length (25b), making poles with the same polarity, on stator axis at both ends (25c), on stator blades, in the same way as on the polar pieces (at multi stage turbine), or any combination of these. The magnetic field is radial closed through the polar pieces and the rotor blades, and then axial through the interior stator yoke, and then again radial through the lateral shields of the case and then again axial through the case yoke. The magnetic induction of this field reaches a maximum when the rotor blades are positioned between case reinforcements and the stator blades, filling this space with ferromagnetic material, and is closing to zero when the blades are completely exiting this space. This field induces in the rotor blades which are moving, a current along the blades, having all the time same direction, and whose level is oscillated between a minim and maxim, depending of the blades position versus the stator fittings and the one of the case. The induced currents all over the blades are summing up in the rotors crowns (25e), are collected through a brushes system (25h), and evacuated through conductors which cross radial the stator (25g), through the channels 25f. For a better collection of the electrical current and for avoiding the over heating of the blades, inside them one can fix aluminum or copper bars, which can make a similar cage to the one of the asynchronous engines. If the number of the rotor blades is not an integer in a ratio with the number of the stator blades, the magnetic induction reaches the maximum value in each blade at another moment, so that the resulting electrical current reduced more or less, depending on the blades number. Also, for a different number of blades between rotor and stator, the uni-polar generator becomes a machine, with the interference and energy produced by the turbine, which can be collected through a winding which is fixed axial in the case, in the notches made by fittings, removing the brushes and receiver. If on some parts of the blades magnetic yokes are introduced as for the hetero-polar generator, creating full sections (crowns), in the respective sections the air gap is constant and minimal, the magnetic induction is maxim all the time, and the electrical currents produced, are maxim as well.

At higher powers of the turbine the lateral shields and stator yokes can became sizeable, that's why taking advantage of the developing in length of turbine and the fact that the stator is the one made around the central axis, they can be significantly reduced by dividing the magnetic flux (25D). In this situation, the lateral shields (25n) and the polar crowns (25e) can be executed from non magnetic materials. The electrical currents produced in the lateral generators have opposite directions to the one produced in intermediate generator, so that the internal crowns next to it become electric isolated one from each other and will use the brushes (25h) distinct for each and one of them. A caged turbine with big length equipped with embedded uni polar generator, will be made of a succession of these types of generators, polarization in different directions, which can significantly reduce the magnetic unilateral forces that are met at this type of generator. Further, making the air between stator and rotor blades, much smaller than the one between rotor and case, the attraction magnetic force can be partially compensated by the pressure with which the thermal agent presses on the blades. The generator being reversible, any of the generator types described can become an engine, through introducing an appropriate voltage through exhaustion clamps. This thing is very useful at the turbine is start up.

From all types of engines incorporated in the caged turbine, the most efficient one is the engine with two rotors (which is installed on a Ljungstrom type turbine), because the relative speed of rotating magnetic field is double versus the one of an engine with stator and rotor. The efficiency can further increase for multi stage turbine, where one can make several engines, with rotor glass like, introduced one into another. At the engines with submerged poles, where the winding is executed in cuts, the air gap (respectively the air gaps at multi stage engines) can be reduced to minimal through a careful processing of cylindrical surfaces by filling in the cuts followed by covering the entire surface with a very thin film (at hundredth millimeter type) from a material with good mechanical and thermal properties (for example Teflon). The resulted cylinders can slide one into each other on a very thin film of oil under pressure. Besides, the cage construction type, with stator in the middle of engine, allows that by appropriate shaping of the blades, first rotor step to become a centrifugal compressor, which can train cold air from environment through the central internal space and it pushes it towards the ventilation channels from next stages. By shaping this channels same as for a turbine, the consumed energy for capturing and compressing the air is partially recovered through the motive effect created by the sparse of the air between the blades walls, especially after the absorption exhausted heat from its conductors and accessories.

The caged centrifugal compressor (FIG. 27), is a building element for some multi stage caged turbines with intermediate combustion chambers, which through appropriate shaping of the blades of some stages previous to the combustion chambers a recompression of the thermal agent is done, but because of its advantages it can be also used independently. Constructive, it looks like the caged turbine, the blades profile being the only difference: the stator has the blades similar to the ones of a classical compressor, and the rotor has the same type of blades like for the compressor with closed channels. Compared to the classical centrifugal compressor, the admission axial pipes and the ante-rotor are missing, the gas intake being done through the central axis, and the blade channels are completely closed between the two blades (27b) and rotor blades (27c), unlike the classic compressor, where the case is used as partial closing element. The debit modulation between the admission and exhaustion is done with profiles fixed between blades (27l), forming, as well, complete closed channels. This allows fixing on the blades of some uni-directional valves (27g), which can grow the stability while.

Combustion rooms (FIG. 28). Because of those constructive characteristics, the caged turbine can incorporate combustion rooms, heat exchangers, steam over heater, etc. in central space or in different turbine stage. Those elements are similar to the classical ones, having the shape and sizes computed in assembling moment. Also the thermal agent of cages turbine can be supplied by an engine with internal combustion, which can be a classical one or can have some changes for accommodating this type of turbine. FIG. 28 shows the method of construction of engine, and in FIG. 12.B the way when the supply of the working agent of a turbine with gases in closed circuit. The engine showed in the figure is made of a cylinder for air compression and another for fuel combustion, being rational separate of those two functions, because the necessary materials for making combustion rooms are more expensive, cooling them can be made in different ways (the cylinder temperatures being different), and the debit air necessary for completely burning from combustion cylinder (possibly from a combustion room from inside turbine) can be measured exactly through diameter change or a length of compression cylinder. Those two cylinders can be fixed in the same cooler room (28.h), or in different rooms. The engine cylinder can be additional activated (28.e), by one or more compression cylinders, also the compressed air producing which is necessary for cooling the adiabatic area, and also for filling the tank used for starting off the turbine. The fuel is introduced using a pump and some pipes (28.g). Combustion can be also at constant volume, but preferably a constant pressure, fuel injection during the entire piston race, and after race finish, on return way, through injecting with fuel from the other part of piston. In this way, the engine becomes a one time engine, introducing power during all its functioning period. the engine is not working using another mechanical device, has no ineptitude, function being conditioned only by air introduction and fuel burning. The optimal effective power is obtained when the injection and fuel burning can make all time race, air relaxation can be only in turbine, which can take the active couple, engine having only a producing role and distribution of primary agent, possible for some auxiliary services actions. If this is wanted a part of active couple to be supplied by the engine, its piston is joined with turbine shaft through crack rod system.

For the turbines working with hot gases and where an efficient sealing of the piston rod passing through the cap of the cylinder can't be made, the motive cylinders are made like for the engines in the current development stage, with one open end, the pistons being coupled through a push and pull system, or if the cylinders are back to back through a common rod.

The, compressor is a double effect one having both times active times, and the piston cover is manufactured with a series of holes (28p) placed toward its basis so that when the piston reaches the end of the path the pressures on the two sides of the pistons are equalized and the start of the compression is not anymore preceded by an expansion phase. The piston movement is done in the same time with the movement of the motive cylinder, the compressor's valves automatically opening while the engine's valves are actuated by tappet valves. In the first phase, the valve 28.4 being open and allowing the entrance of the compressed air from the compressor into the combustion chamber and the valve 28.1 allowing the compressed air into the turbine, the fueling valve 28.r is opening (if needed, after a pre-heating with incandescent plug sparking) and the fuel combustion happens, which leads to the movement of both pistons and the opening of valve 28.6 through which atmospheric air is suctioned. After a short travel of the piston, the valve 28.7 is opening through which the compressed air is exhausted from the compressor, situation that doesn't change until the end of the path of the pistons. At the end of this path, using some tappet valves, the fueling valve 28.r is closing and the valve 28.t is opening, the valves 28.4 and 28.1 are closing and the valve 28.3 is opening to intake the compressed air and the valve 28.2 to fuel the turbine. After combustion and a short piston travel, the valves 28.6 and 28.7 are closing and the valves 28.5 and 28.8 are opening so the cycle can continue.

Types of caged turbines. Depending on the thermal agent characteristics and on the characteristics of the applications where the turbine is used, the elements previously described can be differently combined, resulting different types of turbines.

Mono stage centrifugal caged turbine is made of a stator and a rotor with its adjusting elements. Depending on the application needs one can add on top a case, regulating elements, elements of the lubricating system, sealing elements, embedded electrical generator, starting engine, combustion chamber or heat exchanger set up in the central axis. The functioning Of the turbine is identical to the one of a classical radial centrifugal mono staged turbine, but the blades of the rotor are much longer ensuring its functioning with much smaller pressure falls on a single stage. The intake of gas, steam or liquid is done through the stator cylinder and the exhaustion can be done directly into the atmosphere (between the rotor blades if the turbine has no case or through a pipe set up on the case or prolonging the stator pipe), or in a condenser than can be even the turbine case. Except for the applications where the mono staged classical turbines are used, for bigger lengths of the turbine the caged turbine can replace classical multi staged turbines. As well, the caged turbine can use thermal agents with very low temperatures and entry pressures.

Mono stage centripetal turbine (FIG. 30) has the construction and functioning similar to the centrifugal one, the difference being in the stator setup (30a) between the case (30c) and rotor (30b) and in the reversed circulation flow of the motive agent. Following that, both the profile of stator blades and the one of the rotor blades is adapted to this flow direction. This type of turbine can be used in the same applications where the centrifugal turbines are used, but where the flow direction from exterior towards interior is more advantageous form the construction point of view (for example when the turbine is placed in a high temperature environment and there is a significant heat introduced through the turbine cage)

Mono stage reversible turbine (FIG. 29) is featured with two stators (29c) and straight (29e), lenticular (29d) or shaped rotor blades, being able to work both centrifugal and centripetal, depending on the sign of pressure difference between the central and peripheral chamber. The computation of profiles for both the rotor blades as well as for the stator blades has to include the need of rotation of the rotor in both directions. The blades of the stator can be full or with internal admission chamber. This type of turbines is useful in the reversible applications, for example in a climate installation that gives the agent during the day in a centripetal way and during the night in a centrifugal way.

The hydraulic caged turbine is identical with the thermal one from constructive point of view, the profile of the blades being computed for the characteristics of the working liquid. The intake pipe is linked to a pressurized tank in which the pressure is maintained constant by a gas pillow (in the case of the condenser of a fridge installation it is about the vapors of the refrigerant). The exhaustion is done in a low pressure pipe in which the working gas is also found. The turbine is preferably manufactured with vertical axis, but can be also manufactured with horizontal axis in which case the stator only has nozzles on a sector from its circumference, specifically on that sector on which the liquid is only collected in the holdings of descendant rotor blades after exhaustion contributing through its weight at the turbine rotation, the blades being shaped so that when passing through the lowest point the linkage of the liquid from these holdings is complete. The best usage for this type of turbine is in the frigorific installations, where being setup between the condenser and the vaporizer and replacing the detentor used in the current technical development stage, it recovers a part of the energy used for compressing the refrigerant.

The multi staged radial turbine (FIG. 31) processes the available enthalpy fall in several successive stages, each stage being built like a single stage turbine. The working fluid is usually the steam or hot gases, but this type of turbine can work as well as a pneumatic engine with cold gases. The primary agent is introduced in the central chamber (31Bb) where it can be additionally processed, and then it enters the nozzles of the first stage from where it expands radial (centrifugal) or radial-axial up to the peripheral chamber (31B.c) from where it is exhausted into the atmosphere or is collected and re-introduced in the turbine circuit. A centripetal expansion becomes possible (and sometimes is wished) only after the last radial stage or after a taking of gas. If the small turbines are usually pipe turbines, being set up on the pipe that supplies them in the position of the pipe and being hold by the pipe, the larger turbines are placed on a support and can have the main axis an horizontal one (31A) or a vertical one (31B).

The rotor blades can be manufactured with action or can have a certain degree of reaction. For this type of turbine a reaction degree as high as possible is preferred, being possible to obtain a reaction degree of 100% by manufacturing the turbine with two caged rotors (Ljungstrom) that rotate in opposite directions, turbine that has longer blades versus the classical variant and supported at both ends.

The ends of the stator blades (FIG. 31A.b) as well as of the rotor blades (31A.c) are each fixed on two rings (31.A.d and 31A.e respectively), one of them having a sliding or rolling bearing (31A.z) and the other ring being rigidly fixed on a cap (31A.3 and 31A.4 respectively). The rotor cap is fixed to the shaft and the stator cap is fixed to the frame, directly or through a sliding bearing that takes the high axial dilatation. In the case of long blades, for a better repartition of the blades weight, both rings can have bearings both on rotor and on stator, and for very long blades intermediate bearings can be used. In the case of very short blades, the bearings can be missing from both rings, the rotor weight being sustained by the shaft in the console. If the turbine is with vertical axis (31B), the bearings in the superior side are not compulsory, the superior cap being sustained by the blades, some of them can be sized specifically for this purpose). The sizing of the blades, both for the rotor and for the stator has to be done so that it avoids the occurrence of vibrations.

The contiguous rotor rings having the same rotation speed are stiffened by a common cap (31A.3) on which elements for mechanical or electrical coupling are setup (tree; 31A.g,h). At the point of tree crossing the case, a bearing (31A.i) is setup together with a sealing system, easy to be setup due to the usually low pressure in the peripheral area. If groups of rotor stages with different rotation speeds are made, they will have concentric trees (FIG. 31A), will have a mechanical reducer gear between each two successive trees, or their generators will be electrically coupled and the power transmission towards the exterior will be made through electrical cables or current bars, case in which the sealing issue is easier to be solved. The same thing happens at the opposite side of the turbine if this has two rotors. Between two rotor stages with different rotation speed, the stator can disappear if the profile of the blades is computed accordingly.

The multi staged caged turbines can be used in any application where the classical multi-staged turbines are being used. Because of their high capacity and the high centrifugal forces on the rotor blades, the rotation speed of caged turbine is usually lower than the one of the classical turbines with the same power while the number of stages of the turbine is higher. However, this is an advantage as the stator blades (and sometimes the rotor ones as well) can be transformed into more efficient heat exchangers, giving the possibility to realize thermal cycles very close to Carnot and Ericson cycles, consequently with much higher efficiency. Other advantages of these turbines are:
the intake of the primary agent can be done both through the central chamber as well as through the shaped blades of the first stages or of some intermediate stages, through individual pipes derived from the main pipe (31A.j), pipes that link the central chamber to an ring-like channel inside the stator disc. At the entrance in the derivation pipe a regulating vane for laminating the jet of agent is setup, or a mini-turbine electrical generator (31A.l), so that the entrance of the thermal agent into the turbine, in the intermediate steps, is done at a pressure equal or slightly higher to the pressure in the entry stage. In the same time in this pipe, or even inside the blades, one can setup electrical resistances (31A.k), directly supplied from the generator of the respective stage, for the gas turbines derivations of the main fueling and combustion air supply pipes can be setup, and for turbines with exhausted combustion gases a cylinder with internal combustion piston can be setup at the entry in the channel, having the debit and temperature properly setup in order to produce a local re-overheating of the primary agent. Simultaneously, through an anterior pick heat, one can extract a quantity from the agent that will be used for regenerative pre-heating of the supply agent. For the gas turbines, in order to realize the cycles with staged combustion, one can make internal combustion chambers simply by increasing the distance between a rotor disc and the next stator disc. By changing the profile of the blades of the previous stages and transforming them into a centrifugal agent, the result obtained is the same as if now one sets up a compressor and a combustion chamber with the space and corresponding material resources. Re-overheating is computed such that after the primary agent supplied from two different sources is mixed, the temperature of the mix is equal to the temperature of the agent at the entry of the turbine. This way the pick-heats, corresponding pipes and the over-heaters are eliminated and the re-overheating is done continuously and not in stages. The maximum effect is obtained through total independence of each stage in this area. This way, increasing the length of the central combustion chamber and making a lateral combustion chamber, on the exterior side of the stator cap, introducing separating screens after each rotor and setting up a pipe system that leads the whole flow of agent used by one stage through the combustion chamber and then through the channels of the blades in the next stage, (path where except for a re-heating up to the initial temperature, the agent debit is supplemented up to the limit, with the pressure increase up to initial value), an area producing high mechanical work is produced, at the end of it the debit, pressure and temperature have maximum values, and the starting diameter for adiabatic expansion is higher.

Same thing can be realized by introducing primary agent in the rotor blades (where a reactive effect of the agent is also obtained) the ink between the fixed ring-like pipe and the ring-like pipe on the rotor disc is done through two ring-like bearings (31A.m). This way, in the first stages of the turbine, exactly the ones with the smaller diameter and higher rotation speed, an isothermal area is created, and area where on top of the high increase of the primary agent debit and the additional energy, the expansion of the working agent is practically done isotherm, with maximum efficiency. At the limit of the isothermal area the situation is identical with the one in a turbine with the same diameter as the larger central chamber, where primary agent with the same temperature but with a low pressure is introduced, the difference being in the energy quantity already produced in the isotherm area. From this point of view, this type of caged turbine, having only the central chamber, the isotherm area and the case, can work as a forward turbine for a classical or caged turbine. For the gas turbines with a separated circuit for the combusted gases, recovering their residual heat is done through heat exchangers whose pipes are setup inside the stator blades (at lower temperatures are exactly the blades walls).
Depending on the installation particularities, the installation for which the turbine is part of (industrial or private central, powering a vehicle, auxiliary turbine, etc) and on the primary agent availability as well as on the consumption needs, different solution for the last stages of the turbine can be adopted:
a) the primary agent is expanding adiabatic up to the peripheral area; where it reaches a pressure and temperature given by the conditions of the exhaustion of its agent or of the heat it contains (24B)
b) the peripheral area is under-heated using a heat pump, preferably with a compressor or atomizer or at a constant volume, leading to increasing the available enthalpy fall, so to the increase of turbine power, a decrease of temperature and pressure in the peripheral area, but also to an increase in its volume. For the condensation turbines a speed up of the condensation process is also obtained, as well as the elimination of water pooling installations, complex and with high volume, accompanied by a thermal pollution of the environment. This solution is becoming even more economical as the quantity of heat absorbed from a residual source or a very cheap source, on the path from the vaporizer to the condenser of the heat source, increases and as the energy consumption to transfer this heat is lower. Ideally, in the peripheral area the temperature of the environment is reached, or even a lower temperature if the central is placed in an open environment or thermally linked to it. For the combusted gas turbines, the gas under-heated in the peripheral chamber, before exhaustion, are used to under-heat the refrigerant of the compressors and of the air between the stages of the compressor, as well as of the air suctioned from the atmosphere, so that their exhaustion is done at the pressure and temperature of the environment.
c) the last steps of the turbine are under-heated using some pipes that cross the blades of the stator. This way the volume of the peripheral area is reduced on the expense of the created power. The refrigerant can be the water in the return of a climate installation or of a heat consumer, cooling water in the environment, under heated water in a sequential heat pump, a refrigerator at vaporizing pressure or even the condense or the gases collected from the peripheral area. In this last case for the turbines with condensation the stator blades crossed by the feeding condense of the tank can reach the isothermal area, given that a certain pressure limit that would lead to over-sizing of the blades is not crossed. From this moment onwards, the pre-heating continues by mixing this agent with the vapors taken from the isothermal area. This way a regenerative cycle of the feeding water is obtained, having a maximum number of steps and a perfect carnotization of the thermal cycle. For gas turbines the cooling of the last blades in the last stages is decreasing the difference between the device functioning cycle and an Ericson cycle. All these refrigerants can be also used to cool the stator and rotor blades of the caged compressors, transforming the poles isotropic compression into an adiabatic one or into a one close to the isothermal one.

d) in the case of turbines with condensation, after the primary agent is expanded up to 90%, it can be directed through an intermediate case to a lateral are of the turbine and directed through the blades of a centripetal turbine or a radial-axial turbine. The turbine can be either classical or caged, with a reduced speed in one or more reduction steps, so that the steam expansion can continue without the blades erosion and thus a fraction of the refrigerant enthalpy is still used obtaining an inferior standard, a reduced temperature and pressure and a smaller exhausted heat. The turbine can be radial or radial-axial, with the blades profile for both rotor and stator being computed so that the drops of liquid formed are exhausted through condenser.
the cooling of the blades in the last steps of the turbine by using heat exchangers inside them leads to the manufacturing of blades with increased string and friction losses, found in the increased temperature of the refrigerant in the peripheral area for the same pressure fall. That's why this method has to be completed or even replaced with introducing cold primary agent (obtained by taking gas from condenser's exit) or cooled steam (that was used for heating the condense) at a given pressure and capacity, in the rotor blades or/and stator blades in the adiabatic area (which now becomes sub-adiabatic). In the same step a pre-determined quantity of refrigerant is extracted to be used for pre-heating the feeding agent, making the cycle close to an Ericson, respectively a Rankine one. The valves or micro-turbines placed at the entry of the pipes feeding these blades, as well as at the entry in the pipes in the isothermal area, can be used to regulate the speed of the turbine.
the central chamber can be also, used for other purposes except the one of distributing the primary agent towards the first nozzles (directly or through a separation with an intermediate shield): combustion chamber (FIG. 31.A), supra-heating of the refrigerant introduced in the nozzles of the first stage or in the blades, boiler chamber for a steam turbine (in this case the gases resulted from the combustion can become primary agent for a gas turbine attached to the steam turbine), distribution chamber with pistons; place of attaching the gas compressors (33b,33n), the last compression stage, etc. For the gas turbines, the role of last compression stage can be played by the first stages of the turbine. Thos way, the gas is introduced in the central chamber from where it is intake and centrifugally compressed by the first stages, being introduced in an intermediate burning chamber open both towards compressor and towards turbine, where the combustion is produced under constant pressure. This way the installations using caged turbines become very compact and they can contain all the components in the same case.

For the closed circuit gas turbines, the centrifugal compressor can be moved on the last stages (33d). This way the gas expansion finishes inside the turbine, before those stages, and the turbine case (33l) becomes also the case of the compressor). The peripheral chamber that communicates with the central chamber (33a) at one or both ends becomes much smaller. In the peripheral chamber the compressed air is cooled (33c) and than intake by the compressor (compressors) of the second stage (33b) and introduced in the combustion chamber, all these being placed in the central chamber. Again the degree of compaction of all these elements of the installation is remarkable. After the first stage (33k), a high speed one realized with gases introduced from the combustion chamber through valves adjusted in the stator blades, a combustion chamber (33i) at constant pressure is created. The gases brought back at the entry temperature are expanded in the low pressure stage (33j), a slower one, with long channels, with stator blades with increased string, cooled with under-cooled water from the sequential heat pump. Cold compressed air produced by compressor 33n is introduced inside these blades. The next blades are shaped to realize a centrifugal compression and are also cooled. The cycle thus realized is close to an Ericson cycle.

FIG. 31A describes a hot air machine. On the case or inside the peripheral chamber there is a compressor (31A u) that suctions the atmospheric air and introduces it through the pipe 31A.y into the ring tube 31A.v placed in the peripheral chamber. Here this room plays the role of a heat exchanger: the batteries of pipes with cold air 31A.x take the residual heat of the exhausted air from the last stage of the turbine and after it is again collected in a tubular ring (31 v′) it is introduced in the central chamber that plays the role of combustion chamber under constant pressure. The needed fuel is provided by a pump (31A.o) and the air needed for combustion by a compressor (31A.p) through the pipes 31A.r and 31A.q both being introduced in the injector with nozzles 31A.s. The warm air enters the first stage through a mini-turbine in the rotor and stator blades of the first stage. After an isothermal and an adiabatic expansion the air reached the peripheral chamber at a slightly higher pressure than the atmospheric one, from where it reaches back to the atmosphere after it releases the residual heat. The turbine also has a lubricating installation (31A.1,2). All the components that are presented on the case in the drawing can be also placed inside it obtaining a maximum compaction level.

The caged turbine configuration, focusing the high pressure elements in the center of the turbine and the ones with lower pressure towards exterior, gives an increased safety level to this type of turbine. Any damage that could appear in the high pressure area, for example a broken pipe, has enough volume available for expansion so that the exterior case is only slightly solicited, or if the case is also damaged, the gas leaks do not have damaging temperatures or pressures. This makes the usage of caged turbine fit for boilers used for heating different types of living spaces.

The turbine in radial-axial cage (FIG. 12) differs from the radial cage as the expansion of the primary agent in the central chamber is done in all directions (FIG. 5). The axis of radial blades in this type of turbine can be a circle, an ellipse or the generator of any other rotation speed body. FIG. 12 presents a multi stage turbine with cylindrical cages. Because the expansion efficiency is lower for small diameters the first stages will have radial cages (12.a). For the next stages each stage of both rotor and stator of the turbine will be made of two discs on whose circle the radial blades are placed (12.b). All the discs (including the one for the stator) are made exactly like the rotor discs of an action axial turbine in the current stage of development (12.c): a circular disc on whose circle the axial blades are placed and with the profile computed based on the cumulated knowledge about gas circulation through blades. The difference between rotor and stator only appears in the profile of the blades and the way they are fixed on the block: in the case of the stator a disc is fixed on the nave (usually the central chamber) and the other is supported by the rotor shaft through a bearing; in the case of rotor a disc is fixed on the rotor shaft and the other is supported by the stator nave through a bearing. For Ljungstrom turbine, the stator nave is not fixed anymore, it is a shaft that is supported by the central chamber through a bearing and by the shell through another bearing. For more rotors with different speed concentrically shafts are built. The axial blades are longer than the length computed with a segment having the same width as a radial blade. The radial blades are introduced and fixed to the axial ones exactly in this additional length. A simple assembly procedure is to fill in the inter-blades channels of this additional length with filling material processed accordingly. The lateral ring of the rotor and respectively of the radial stator is obtained by welding them to the blades. The radial blades can be placed by creating wholes or notches in this ring. Things are presented as we would have two classical multi stage turbines for which the diaphragm with nozzles is replaced by stator disc with blades between which a radial caged turbine is placed. All three turbines are fueled form the same combustion area, have the same shell and the same auxiliary installations, being more compact than the group of 3 independent turbines.

Usage. The caged turbine has a wide series of usage cases due to the high number of advantages it presents. The caged turbines can be used in all the applications where a classical turbine is used. On top there is a multitude of new usage cases because of their constructive shape, few of these cases will be presented here. The one stage turbines or even the 2-3 stages turbines can be used wherever there are residual pressures or temperatures, transforming these energies into an easy to use form of energy (electrical): on the pipe exhaust of any internal combustion engine, the line blowdown of any installation replacing the pressure reducer, on the exit pipes of compressed fluid tanks to adjust the pressure and capacity at each working point depending on the needs, replacing the laminated cock in fridge installation or another type of installation, between the vaporizer and the condenser of a heat recuperator with refrigerant (request PCT/RO/2006/000015) for using the temperature difference between ground and atmosphere, for using the temperature difference between the sunny and the shadowed side of a building, etc.

1. Improving the functioning cycle of steam and gas turbine. A series of elements part of the cage turbine structure can be implemented on the turbines in the current technical stage to improve their functioning cycle: placing electrical mini-generators to feed the local auxiliary circuits and some resistances for heating the primary agent, introducing thermal agent or/and heat through the static blades (or through static chambers created by replacing some blades) in some steps to realize a multi-isotherm expansion, introducing cold air in the last steps in the same way as described above to realize a sub-adiabatic expansion, creating a regenerative cycle of pre-heating the fueling agent by passing it through pipes placed in the static blades, adjusting the capacity and power by changing the entry angle of static blade while working, cooling the condenser of the steam turbine, the peripheral chamber of gas turbine as well as the cooling of the water used to cool the compressor with a sequential heat pomp, etc. All these improvements bring significant economy in the material used for manufacturing turbines and reduce the quantity of fuel used

2. Improving the functioning regime of current thermal centrals

3. Low power thermal centrals. The caged turbines are recommended to be used in manufacturing thermal centrals used to heat apartment buildings due to the high safety this type of turbines is providing. The fuel is used for producing steam or for warming a gas which is later expanding producing electrical energy and reaches the peripheral area of the turbine with a pressure close to the atmospheric one. If a steam turbine is used, its condenser is crossed by return pipes of the heating installation and the one producing the warm water used in-house, giving away the overheating or the vaporizing heat of the exhausted steam. The condensed liquid is taken by a pump and re-introduced in the turbine circuit. The temperature and the pressure in the condenser are adjusted depending on the heat quantity needed for warming. The system is identical to a classical warming system, having all its advantages, but on top it doesn't uses the long pipes between the electrical central and the consumers, hence doesn't have any losses on these pipes. The usage of fuel and the price of this central is higher then for one without turbine, but this is compensated by the increased efficiency for obtaining the electrical energy and the option of having a self owned energy source when any damage in the system. This type of boiler can have the option to be linked to a heating installation or a heat pomp based on solar barriers. The heat produced when condensing the refrigerant is cumulated and used for example during the night when the efficiency of the turbine is lower.

4. Improving the functioning cycle for internal combustion engines. Any practical application that uses an internal combustion engine can increase its efficiency using a piston turbine as described in this invention, or just the engine of this turbine, together with a mini-turbine placed on the exhaustion pipe of the burn gases. The advantages of this type of engine are:
an increased capacity for compressing cylinder
separating the compression function from the motive one
ensuring a constant couple through the energetic increase brought by the usage of the turbine and through the continuity of the active couple of the piston engine
significantly decreasing the volume of the engine through an admission and combustion with no interruptions
eliminating the starter, alternator, and starting battery by replacing them with the turbine generator
the option of an easy start using an compressed air tank
the option to place a heat pomp to increase the turbine performances that ensures the recovery of the heat in the exhausted gases, an efficient cooling of the engine and compressor and provides the thermal agent for the internal climate system
reduced fuel usage

5. Improving the compressor functioning. The effect of increasing the compressed gas capacity at the came cylindrical capacity can be obtained by producing some slots in the liners of the piston (FIG. 8p). This way, when the piston reaches the end of the path the pressures on he two sides of the piston become equal and the two valves are closing. When the piston movement in reversed direction is restarting, in the chamber with small volume the admission valve is opening much faster, so that the gas expansion till the atmospheric pressure starts from a much smaller supra-pressure. Hence the volume of gas absorbed is higher and in the opposite chamber the compression starts from a pressure slightly higher than the atmospheric one, this way the capacity of the compressor is increasing.

B. Operation of the system. The receive of energy can be achieved directly, from the source of energy, when the receiver is placed in the geothermal water source, in soil, in the warm gas currents provided by an industrial equipment ventilation plant of a building, in the gas currents coming out of an exhaust, in direct contact with a machinery or a part of it that needs to be cooled, in a solar, etc, or indirectly, when it is contact with the walls or the fluid of a heat exchanging receiver, or when it is traveled by one or more pipes with thermal agent, parallel with the shifting axis, in this case the piston being provided with the adequate number of orifices and backing plates. In all these situations, the type of the material, the shape and thickness of the walls of the receiver, as well as the dimensions of some possible fins and flanges (blades), are chosen so that the heat transfer towards the agent inside the receiver should take place at a much higher speed and with more efficiency.

When the sun is the heat source, the entrance receiver can be a gas tank, with metallic walls covered with substances that absorb the solar radiations, in fixed fitting, or which can be positioned, by rotating movements, so that the captured radiation flux should be as large as possible.

The solar radiations can be direct or through several mirrors or focusing prisms. In FIG. 1. A is shown receiver (1a) placed inside a vacuum glass tube with double walls (1b). A part of the inside surface of the inside wall is covered with, a reflecting substance, thus creating a focusing mirror, having the receiver in the focal spot. In FIG. 1. B is presented another version, where the 1a receiver is a copper tube covered with thermal black (1c), placed inside a vacuum glass tube (1b). It is positioned in focal point of a focusing mirror (1d), with walls cooled by a water flow or by the vaporization of a refrigerant.

The WO 2007/018443 patent application describes a system of thermal cover of the buildings, featuring a structure that is perfectly, adapted to support the elements of the thermodynamic system. FIG. 2 presents a plane and a cross section of a building with the proposed cover type. This type of cover is stained by a superstructure made of vertical pillars (2c), reinforced between them with beams, preferably horizontal ones (2j). The pillars are metallic, made of concrete, of stacked wood or other materials and have independent foundations (2a) or share the same foundations with the pillars of the building (2k). The number of the pillars of this superstructure can be different of the number of the pillars in the superstructure of the building, but an equal number is preferred. Between the two superstructures there can be some joining or sustaining points (2f), but their number has to be as small as possible and they have to be made of elements with the lowest thermal transfer coefficient possible. A structure of horizontal beams (2m) is sustained by these pillars (2f), with sustaining points on the pillars of the building (2q), which, absorb a part of the weight of the roof, or a structure of rafters or bolts which absorb entirely this weight. Multi-layer barriers (2b) or insulating plates made of classical materials are fitted on the inside part of the additional superstructure. The covered building (2e) features on the side from the cover several light structures (wood, particle boards, plaster boards, gypsum, plastic materials, etc; 2p), in which active barriers are fitted (2o). The air layer generated between the two superstructures and which, according to this invention, is bordered by reflecting foils, can have, from thermal point of view, several functions:
if its thickness is close to the optimal thickness, it produces a thermos barrier, with heat insulating function;
if the wall of the building oriented towards the cover is a radiant wall, containing an active barrier, the air layer can be a little thicker;
if the sun-oriented facades are provided with collecting elements, the air of this layer can be carried away by a ventilation system, transferring the collected heat towards the other facades;
the air in this layer can be carried away by an air-conditioning system, being its heat carrier agent;

Between each pair of 2 vertical pillars and 2 horizontal adjoining pillars there can be found a series of parallelepiped chambers, bordered on the side next to the building by the insulating layer. If the surface from the outside of this chamber is closed by a glass panel, we have created a solar barrier, inside which the collecting elements from FIGS. 1A and 1B can be fitted. In FIG. 1C we can see being represented such a solar barrier, bordered by the 1c pillars (insulated towards the exterior 1d), by the decorative plate 1b, with solar radiations capturing role, and the insulating layer 1d, inside it being fitted a solar receiver 1a, of parallelepiped shape, with a piston 1e moving inside. Due to the hothouse effect, when the façade is heated by the sun, the temperature inside this barrier is higher than the outside temperature. The hothouse effect is a lot more amplified if the outside plate 1b is made of float glass or low E, of polycarbonates, polythene or other material transparent enough to radiations, and it is covered on the inside with a layer which keeps inside the thermal radiations, and the outside walls of the receiver are painted in absorbing colors.

Depending on the using manner of the equipment, the solar barrier can be provided with additional elements:
a thermos heat-insulating layer 1g, placed between the barrier and the insulation 1d;
a heat exchanger 1h fitted between the receiver and the and the insulation. It becomes a simple heat retainer, if the thermic agent in the exchanger does not move, or it can realize a heat exchange, positive or negative, with a tank-heat exchanger, if the thermic agent is moved by a pump, from the receiver when the sun doesn't shine, or from the retainer in the rest of the time. The exchanger can also bring an additional heat or coldness supply from another unconventional source, if it is connected to a receiver placed in the ground, in a river, in a ground-water table, in a geothermal spring, in the corrupt air flow exhausted by the ventilation of the building, etc.
a mobile curtain 1f, fitted between the exterior plate and the receiver, which thermally insulates the enclosure in the shadowy periods of time.

The exterior wall of the barrier can be a double one: both plates are made of a transparent material or only the exterior plate; the interior plate being made of an absorbing and heat-retaining material, a thermo-insulating curtain rolling between the two plates or a thermic agent (air, water or another fluid) circulating, that can recover a part of the heat which could be wasted through exterior, in order to pre-heat the thermic agent in the receiver. In the same time, the supporting pillars 1c can be empty on the inside and can have the function of storage tanks, of air drains, a place to lay the pipes which connect differents elements of the equipment, etc.)

An identical structure can be featured by the solar barriers that form an the roof of the building, at its covering, either it is inclined, vaulted or terraced. The thing that is different, first of all, is the incidence angle of the sun rays, and the possibility of fitting some focusing mirrors, which can turn the sun rays in a more direct manner, even on the barriers placed on the north-oriented side of the roof. Likewise, the design of the equipment can be realized in such way to heat up the barriers, during a snowfall, in order to melt the snow, avoiding the temporary placing out of operation of the equipment.

Entrance receivers, of cylindrical or parallelepipedical shape, can also be placed on the walls of south-oriented barrages and dams, visibly or burried in a shallow concrete layer, covered with an absorbing film. In case of an unproper orientation, a field of focusing mirrors captures and redirects the sun rays in the adequate direction. In case of roads and highways, the warm receivers are fitted in the upper part of the concrete foundation, the road carpet absorbing the solar radiation and retaining heat, and the cold receivers are fitted under the concrete foundation, at a more greater depth, the ground area that makes the thermic transfer being extendable with the help of some vertical bars, according to the procedure described in the invention. Both the cold and warm receivers group in sequential heat exchangers, in isochore-isobaric compressors and in Stirling compressors. On this base we can build a thermodynamic system which could supply an agent to a caged turbine or to a bank of Stirling engines and, besides that, it could heat up the road during winter, avoiding the glaze formation, or it could cool it down during summer, avoiding fasy damaging.

On the ground, the receivers and the afferent equipments can be fitted in separate enclosures, actually solar electrical power plants. Receivers with high interior pressures and gases that are not usable in populated areas can be used in these enclosures.

In areas with high wind intensity, wind turbines can be build and the warm receivers should take over the function of the blades. PTS can also be placed on the surface of lakes, rivers or seas. Since they contain a large volume of gas, the receivers can float on their surface. Here are high temperature differences between the air in the atmosphere and the water from a certain depth, there are intense solar radiations, there are winds and regular waves, and there could be tides or variations or the water level in the storage lakes of the hydro electric power plants. An example of combining these two availabilities is presented in the FIG. 20B.

The simplest PTS is the one with a single compression step, composed of a Stirling engine with the warm receiver placed in the warm source and the cold receiver in the cold source, the power receiver being placed in one of these sources, or with one head in the cold source and with the other in the warm source. Between the two receivers we fit the two recuperators (with a working agent having a higher thermic transfer speed), or a heat exchanger in counter current, simple or sequential. A similar cycle can be achieved with a caged (framed) turbine (FIG. 17), which runs on a pressure drop pulsating between a maximal value and zero (the pulsations fade out if a set o identical turbines run in parallel, with an adequate lag). The cycle is similar to the cycle of the Stirling engine, with the difference that in the turbine the expansion is adiabatic, phenomenon which is balanced by an additional heating of the receivers.

In order to obtain superior efficiencies, PTS is realized in more steps, an increase of power and more efficient thermic exchanges being obtained. The composition of an PTS with more steps (FIG. 18) is the same as the composition of a gas turbine equipment, at which all the component elements are replaced with the elements described in the invention, capable of running with small temperature and pressure differences. At an equipment with open circuit, the air is taken over from the atmosphere by a Stirling compressor (18a), or by an isochore-isobaric compressor (when there are higher temperature differences between the cold source and the warm source and there are consumers or an available storage tank to take over the heat excess), equiped with one or more types of engines that deliver constant pressure (depending on the characteristics of the unconventional source, of the available space, of the nature of the environment where the equipment is placed, of the purpose of the equipment). After reaching a pre-established pressure (through an isothermic, respectively isochore-isobaric compression), the gas is introduced in a heat-exchanger (18c) at constant pressure (or succesivly, in a bank of constant pressure heat-exchangers), where its temperature is increased as much as possible (with focusing mirrors, with receivers supplied with heat-resistors, helped by the heat yielded by a heat pump with constant volume compressor). The role of this exchanger can be taken over by the last steps of the compressor. If there is a possibility to fit in a liquefaction equipment, the pressure can be increased even more in a receiver with pulverizer, in ishotermic regime.

After reaching the maximal pressure and temperature, the gas enters in a caged turbine (18b) or in a receiver with linear generator, where it expands up to the atmospherical pressure (the pressure difference compared to the atmosphere can be distributed on two or more turbines that work with less input-output differences) and it cools down, producing electric energy or mechanic energy, depending on the needs. The temperature at the turbine output can be aproximmately equal with the atmospheric pressure and when the air is discharged in the atmosphere it can be higher, and then it is recovered in a heat-exchanger (18d) or in the vaporizer of a heat pump with compressor at constant volume, or it can be lower, then it can be used in an air-conditioning equipment or used to cool an agent or several receivers.

If the work agent is not the air, the equipment is built in close circuit, the discharge of the turbine being made towards the compressor, with intermediate heat-exchanger. Every time when it is possible, even if it requires to fit in some heat-pumps with compressor at constant volume, any heat release is recovered and stored to be used when the temperature difference between the warm and the cold source decreases too much.

An PTS which runs on vapors follows a cycle that has an efficiency superior to the Ericson cycle. The vaporization at a certain temperature, followed by an over-heating at constant pressure and an adiabatic expansion cannot be realized with usual unconventional sources. That's why the working liquid (alcohol, for example) is compressed and heated till the maximum available temperature, when it is vaporized till saturation (the heat required to the vaporization is lower as we approach the critical point) and it is immediately introduced in a receiver provided with pulverizer, with linear generator of electric energy. Immediately begins the pulverization of a gas with a higher vaporization temperature (water, for example), which continues till it reaches a pressure at which the introduced gas doesn't liquefy anymore. All this time, the pulverized gas release is adjusted so that by the liquefaction should be released exactly as much heat to compensate the cooling by decompression of the work agent, the process being quasi-isotherm. From this moment, the expansion is made adiabaticly, in a caged turbine, without gas pulverization, till the reach of the saturation point, at a much more decreased temperature and a much lower pressure than in a classical equipment. In most of the times, the extraction of the heat released through condensation should be achieved with the use of heat-pump with compressor at constant volume, with a vaporizer fitted in the condenser of the turbine. The cycle followed by the process, is very similar to a Carnot cycle.

In the case of very small temperature differences between the the warm source and the cold source, in the composition of the is found a heat-recuperator with refrigerant agent, having a vaporizer that should be heat-insulated as well as possible. The starting of the equipment is achieved with a Stirling engine (which in the first phase can run as a heat-pump, receiving electric energy from the exterior, or it actions like a compressor), which increases the temperature difference between the vaporizer and the condenser, till this function can be taken over by a compressor with constant volume, the Stirling engine becoming a linear generator. The Stirling generator absorbs from the vaporizer a certain amount of heat, releasing the rest to the condenser. The compressor with constant volume takes from the surrounding environment the caloric equivalent of the power released by the engine and transforms it into energy for compressing the vapors. The other part, necessary to the adiabatic-isothermic transformation, is taken through the vaporization of additional amount of liquid refrigerant from the condenser. This additional part, after running the adiabatic-isotrope cycle, will condense in the condenser of the heat recuperator, releasing a certain amount of heat. By increasing the discharge of the compressor with constant volume the temperature in the vaporizer decreases even more (the temperature variation which lies beneath the generation of power by the Stirling engine increases, and so does the released power), while the temperature in the condenser maintains itself constant, through controlled pulverization, the temperature difference compared to the environment increasing and the system being capable of absorbing more heat in the receivers with pulverizers. The temperature difference between the arms of the recuperator is made available by a bank of double-gamma Stirling engines, which have the receivers submerged in the two arms of the recuperator, this type of engine being an ideal consumer of the heat released by the condensation of the refrigerant By insulating the vaporizer, the entire amount of the heat that it absorbs comes from the heat released by the Stirling engines, their capacity being maximal. If there are consumers capable to take the heat from the condenser at that temperature (for example, another Stirling engine), the vaporizer is not insulated and thus takes place an additional heat supply from the environment to the vaporizer, heat which is absorbed from the condenser by that consumer. Besides that, the bank of receivers with pulverizer can cool down a thermic agent which would be the cold source for another bank of Stirling engines, or, better than this, these receivers are divided in sections which are each submerged in basin not being thermal insulated, containing refrigerant. The Stirling engines that have the cold receiver submerged in these basins and the warm receiver submerged in the condenser of the main recuperator transform into mechanic or electric energy the caloric equivalent of the difference between the heat amount that additional liquid amount from the condenser releases to the warm receivers through condensation and the heat amount that the same agent amount absorbs from the cold receivers through vaporization in the compressor with constant volume. The rest of the heat necessary to run the compressor at constant volume is absorbed from the surrounding environment, by the heat absorbed through the walls of the basins with refrigerant and it is made available through the Stirling engines. In order to accelerate the compression process, the last part of the adiabatic compression and the line of the isothermic compression progress with an additional heat supply, by using some receivers provided with thermo-resistors, supplied with current generated by the braking processes, by the energy produced by the generators, by fitting an additional heat pump, or from outside the system.

As we can see from the energy balance, this type of PTS is able to produce considerable amounts of energy, using unconventional sources with extremely low power potential.

1. Progressive Thermodynamic System (PTS) for heat conversion into electrical or mechanical energy, characterized by the fact that it is made of a series of receivers and constant volume heat exchangers, a series of isochoric-isobar compressors, Stirling compressors, compressors with atomizers, compressors with liquid and/or compressors with refrigerant and a series of motive elements (Stirling engine; double-gamma Stirling engine, Stirling generator, pneumatic engine, caged turbine)

2. Thermodynamic system for heat conversion into electrical or mechanical energy, as per claim 1, made of a refrigerator installation or a heat pump, characterized by the fact that the temperature difference between the condenser and the vaporizer of the system is used by a Stirling engine or a turbine

3. Thermodynamic system for converting heat into electrical or mechanical energy, as per claim 1, made of a vaporizer placed in the hot source and a condenser placed in the cold source; partially filled with liquid refrigerant, linked on the inferior side through a liquid pipe on which a pump is placed, and on the superior side through a gas pipe, further called receiver with refrigerant, characterized by the fact that on the gas pipe a compressor is placed with the exhaustion in the vaporizer.

4. Thermodynamic system for converting heat into electrical or mechanical energy, as per claim 1, made of a vaporizer placed in the hot source and a condenser placed in the cold source, partially filled with liquid refrigerant, linked on the inferior side through a liquid pipe on which a pump is placed and on the superior side through a gas pipe, characterized by the fact that on the gas pipe a pneumatic engine or a turbine is placed.

5. Heat receiver for PTS according to claim 1 or for other thermodynamic systems for capturing the heat in the ground, made of a system of horizontal pipes covered by a metallic foil or by a layer made of material that accumulates heat, characterized by the fact that it has a network of vertical rods (FIG. 3d) that absorb the heat from deep in the ground and transfer it to the pipe system.

6. Heat recuperator for PTS according to claim 1 or for other thermodynamic systems, made of a series of filaments perpendicular on the direction of the gas flow, characterized by the fact that closed tubes with saturated refrigerant are interlaid among these filaments.

7. Device for fluid motion for a PTS as per claim 1 or for other thermodynamic systems, called from now on receiver, characterized by the fact that it is made of a tank with a translation body shape and the section perpendicular on the translation axis in any shape, driven by a piston that splits the tank in two different rooms with no connection between them, each having intake and exhaustion valves and with the piston being able to move from one end to another of the tank without loosing the sealing between the two chambers.

8. Receiver as per claim 7, characterized by the fact that the sealing between chambers is ensured by one or more fittings that have an inflatable internal chamber filled with pressurized air.

9. Receiver as per claim 7, characterized by the fact that between the two covers and the respective face of the piston there is a system of articulated bars that fold and unfold together with the piston motion.

10. System made of one or more receivers as per claim 7, placed on the same axis, with a common rod, characterized by the fact that the pistons motion is done through the rotation of a gear coupled with the common rod through an adherent contact or a mechanical couple.

11. System made of one or more receivers as per claim 10, characterized by the fact that changing the direction of the piston motion is driven by the motion of a trolley with gears attached, motion that leads to introducing or eliminating from the cinematic chain of a transmission gear with the same diameter as the one of the gear it moves (FIGS. 6 and 8)

12. Receiver as per claim 7 characterized by the fact that on the two faces of the piston the ends of a flexible rod are coupled, rod that is straightened and moved by a gear system (FIG. 5D)

13. System with two vertical receivers as per claim 7, characterized by the fact that their pistons are coupled through a common flexible rod in order to reciprocally compensate their weight during the motion.

14. Receiver as per claim 7 characterized by the fact that its piston is made of two cylindrical wheels that roll sealed and tangent between them and with the superior and inferior walls, having the axis sealed on two trolleys that move in a sealed manner each in one channel produced in the lateral walls of the receiver (FIG. 7A)

15. Receiver as per claim 7 characterized by the fact that its piston is made of a flexible tape with the ends attached to two opposite edges of the receiver with the same width as the receiver's and the length equal to a receiver's length plus a receiver's height, and two cylindrical wheels placed on one and another side of the tape each having the axes sealed on two trolleys that move in a sealed manner each in one channel created in the lateral walls of the receiver; the two wheels are always in a plane perpendicular on the receiver's axis and are moving along this axis so that the flexible tape is always straight and its margins are sealed on the lateral walls of the receiver.

16. Receiver as per claim 7, characterized by the fact that its walls are placed on one and another side of the piston, between the margins of one side of the piston and the margins of the interior surface of the cover and they are made of fragments sealed among them and sealed with the cover and the piston on all edges with hinge type of systems so that at the piston motion toward one of the covers (motion that is done through sliding or rolling along a path parallel with the piston axis) the walls between piston and the respective cover are folding exhausting all the air in the interior through an exhaustion valve at the end of the path, while the walls between piston and the opposite cover are unfolding allowing the intake of additional gas through the intake valve; at the end of the path the walls are completely unfolded forming plane surfaces and obtaining maximum volume in the interior.

17. Counter flow heat exchanger for a PTS as per claim 1 or for other thermodynamic systems, made of two rows with the same number of receivers with the same volume as per claim 7, characterized by the fact that there is a thermal transfer at constant volume between the two rows from a receiver in the first row to the receiver in the second row, so that after a number of completed piston paths (that are all moving in the same time, with the same speed in all the receivers, continuously or with breaks after each path completion), number of paths equal to the number of receivers in a row, the gas is successively passing through all the receivers in the respective row.

18. Counter-flow heat exchanger as per claim 17, characterized by the fact that each compartment is split in its turn in layers between the walls of some plates, the layers of the compartments in one row alternating with the layers of the compartments in the other row (FIG. 20)

19. Receiver as per claim 7, characterized by the fact that the piston is manufactured from a permanent magnet made of a ferromagnetic material or is manufactured as an electromagnet fed with continuous current so that it can be moved by an electromagnet placed on a trolley that moves in the exterior of the receiver along a wall made of a non-magnetic materials (FIG. 9)

20. Receiver as per claim 7, characterized by the fact that inside the piston and/or in its walls, as well as in the receiver's walls electrical conductors are placed with the objective of creating magnetic fields and of producing forces for piston motion (to power the forward-backward movement of the piston) if they are fed with electrical energy or by piston motion electrical currents are induced in these conductors, currents that are collected and provided to a consumer; the electrical links between the source and conductors on the piston are made with collecting brush (FIG. 10i) placed on the piston, that touch a linear collector placed between the lateral walls of the receiver (FIG. 10t) or are made with a system of articulated bars 10u placed between the piston and one of the covers; for changing the alimentation flow for the stator coils a system of lamellas 10o touching a linear collector 10n is placed on the piston in the receiver's walls.

21. Receiver as per claim 20, characterized by the fact that slowing down the piston at the end of the path is done with springs 10p placed on the interior side of the two covers and/or with a gas pillow created between the two covers and two sealed breaking pistons 10b and/or by decoupling the alimentation on the induced circuit and commuting the circuit towards a consumer

22. Receiver as per claim 20, characterized by the fact that magnetization of the receivers walls is done with coils 10c winded (on a thermo-insulating support or in notches) around armatures on the covers (FIG. 10A) and/or with coils winded on armatures parallel with the walls (FIG. 10B2), the lateral walls being the yoke that are closing the magnetic flux through piston.

23. Receiver as per claim 20 characterized by the fact that the magnetization of the receiver's walls is done with winding drum, looped or curled in notches created in the interior walls of the receiver (FIG. 10 I,J,K,L,M,N)

24. Receiver as per claim 20 characterized by the fact that the magnetization of the piston is done with coils winded (on a thermo-insulating support or in notches of the armature) around the piston (FIG. 10L) or with two semi-pistons (FIG. 10M) with the spires in planes parallel with the receiver's axis.

25. Receiver as per claim 20 characterized by the fact that the magnetization of the stator (made of receiver's walls) is done with a single-polar field while the rotor is a massive metallic piston; a piston from conductive sheets placed inside or perpendicular on the direction of magnetic flux flow and moving direction (FIG. 10A,B,C); a horseshoe-like massive piston around the piston rod or around a support in the receiver's axis between the two covers; a piston from sheets having in its axis one or two ferromagnetic rods used to move on a ferromagnetic support and having inside spires winded around the axis in a plane perpendicular on this axis (FIG. 10 F, H)

26. Receiver as per claim 20 characterized by the fact that the magnetization of the piston walls is done with drum winding, looped or curled in notches made in those piston walls that are perpendicular on the direction of the hetero-polar magnetic field created by the stator (FIG. 10 I,J,K,P)

27. Procedure for feeding an continuous current inline engine with alternate current as per claim 20 or any other continuous current engine of derivation type, characterized by the fact that the rotor windings are powered in phase with the stator ones, through powering from the secondary of a transformer whose primary is linked in series with stator windings, or by an alternate current generator in phase with them or form another phase of poly-phased system

28. Receiver as per claim 20, characterized by the fact that it is build with magnetization coils and rotor powering collector only at the two ends, the piston powering being doe with large amplitude pulses with different direction at the two ends

29. Receiver as per claim 20, characterized by the fact that the stator coils generate a rotating field while on the rotor a caged winding is made

30. Receiver as per claim 20, characterized by the fact that notches and windings similar to the rotational engines with field modulation or with the engine with pulsating field or with interference are made on the stator, while the rotor is not being winded but is built with notches similar to the respective rotative engines

31. Stirling type of engine, characterized by the fact that both the movement cylinders as well as the power cylinders are receivers as per claim 7 or 20

32. Stirling type of engine as per claim 30, characterized by the fact that it is made of two receivers with moving piston and equal volume, the ends of one receiver being linked to the other's through heat recuperators or counter flow heat exchangers where the thermal exchange is made with constant volume, and a power receiver that has the entry and exit attached to the two linkage pipes (before or after the heat exchanger).

33. Stirling type of engine as per claim 31, characterized by the fact that it is equipped with several pairs of movement receivers and the corresponding remunerators that are coupled successively at the force receiver

34. Stirling type of engine as per claim 31, characterized by the fact that periodically or at the end of each path of the piston the pressure on its two faces is being equalized

35. Stirling type of engine as per claim 31 named as of now on Stirling compressor, characterized by the fact that it has a pneumatic engine instead of the power receiver, where both the hot gas expansion with another gas compression and the compression of the gas in the cold receiver is happening

36. Procedure for correcting the thermodynamic processes used by PTS as per claim 1 as well as by other thermodynamic systems, characterized by the fact that in a closed chamber with gas drops of a liquid are atomized, drops that are vaporizing at the temperature and pressure in the chamber, cooling the gas in the chamber and increasing its pressure.

37. Procedure for correcting the thermodynamic processes used by PTS as per claim 1 as well as by other thermodynamic systems, characterized by the fact that in a closed chamber with gas another gas is atomized, gas that at the given temperature and pressure in the chamber liquefies, heating the rest of gas in the chamber

38. Compressor for gas compression used by the PTS as per in claim 1 as well as by other thermodynamic systems, characterized by the fact that in its walls one or more atomizers are placed realizing an isotherm compression as per procedure in claim 35.

39. Compressor for refrigerant compression used by the PTS as per in claim 1 as well as by other thermodynamic systems, characterized by the fact that in its walls one or more atomizers are placed realizing an adiabatic compression followed by an isotherm compression as per procedure in claim 35.

40. Heat exchanger for gas compression used by the PTS as per in claim 1 as well as by other thermodynamic systems named as of now on constant volume compressor, characterized by the fact that in its walls one or mare atomizers are placed realizing adiabatic compression followed by an isotherm compression as per procedure in claim 35.

41. Installation for gas compression used by the PTS as per in claim 1 as well as by other thermodynamic systems named as of now on compressor with liquid, characterized by the fact that it is made of a double effect receiver whose piston is moved by the piston of a receiver placed in the flow of a liquid, usually the liquid of a heat exchanger

42. Installation for gas compression used by the PTS as per in claim 1 as well as by other thermodynamic systems named as of now on compressor with refrigerant, characterized by the fact that it is made of a recuperator with refrigerant for which on the gas pipe a receiver with double effect piston with constant load is placed which at the end of each path exhausts in a receiver with expansion or in a pneumatic engine

43. Installation for gas compression used by the PTS as per in claim 1 as well as by other thermodynamic systems named as of now on isochoric-isobar compressor, characterized by the fact that it is made of a row of receivers as per claim 7 in which a gas from a tank or atmospheric air is introduced all along the cooling process at constant pressure using compressors as per claims 35,41,42 or other types of compressors and of a row of receivers where the gas is heated at constant volume

44. Installation for gas compression as per claim 43, characterized by the fact that heat recuperators or heat exchangers are interlaid between the cold receivers and the hot ones

45. Receiver as per claim 7, characterized by the fact that in its walls there is one or more thermo resistances placed for heating the gas inside

46. Thermal or hydraulic turbine for a PTS as per claim 1 or for other thermodynamic systems, characterized by the fact that both the rotor blades as well as the stator blades have both ends fixed on rings placed in parallel planes, with the center on same axis that is perpendicular on the two planes

47. Turbine as per claim 46, characterized by the fact that the stator is manufactured by making notches in a cylindrical pipe

48. Blade made for a turbine as per claim 46 or for other types of turbines or compressors, characterized by the fact that inside the blade, along it, a channel that communicates through nozzle with the space between rotor and stator

49. Electrical generator and engine used by PTS as per claim 1 as well as by other installations, characterized by the fact that the electrical poles are placed on the blades of the device they are rotating or are rotated by

50. On/off or capacity regulator device for a turbine as per claim 46 or for other types of turbines and compressors, characterized by the fact that they are made of a with notches placed inside or outside the stator and which partially covers the stator valves by rotating around the axis

51. Procedure for capacity regulation or compensation for the dilatation of the blades of a turbine as per claim 46 or of other types of turbines, compressors or ventilation devices, characterized by the fact that this is made by the manual or automate rotation of the stator or rotor blades around their axis

52. Thermal or hydraulic turbine as per claim 46 or another type of turbine characterized by the fact that the profile of its blades is made so that the turbine can rotate both ways

53. Procedure for changing the working characteristics of a turbine as per claim 46 or of another type of turbine, characterized by the fact that thermal agent is introduced in the turbine's circuit through channels made inside the blades or in the space created if some blades are eliminated, being possible to heat the agent inside the channels it is introduced in

54. Procedure for changing the working characteristics of a turbine as per claim 46 or of another type of turbine, characterized by the fact that its peripheral chamber is cooled with a heat pump

55. Procedure for changing the working characteristics of a turbine as per claim 46 or of another type of turbine, characterized by the fact that some of its blades are cooled with thermal agent collected from the peripheral chamber

56. Procedure for changing the working characteristics of a turbine with condensation as per claim 46 or of another type of turbine, characterized by the fact that the latest stages have a small speed and are used to expand the steam with small standard

57. Installation for heating different types of living buildings characterized by the fact that it is equipped with a turbine as per claim 46 that introduces electrical current into the network

58. Internal combustion engine used by PTS as per claim 1 as well as by other thermodynamic systems, characterized by the fact that compression and combustion happen in different cylinders

59. Internal combustion engine with double effect pistons used by PTS as per claim 1 as well as by other thermodynamic systems, characterized by the fact that the fuel combustion happens all along the cycle time, one semi-cycle on each face of the piston once the compressed air is intake, while on the other side the gases are pushed into a turbine.

60. Procedure for building acclimatization with PTS as per claim 1, characterized by the fact that the thermal agent is introduced between the external wall and its thermal outer cover

61. Procedure for obtaining electrical, thermal and mechanical energy with PTS as per claim 1, from solar energy or any other source with low thermal potential, characterized by the fact that a vaporizer with the boiling temperature as low as possible is placed in the peripheral chamber of a turbine, the resulting vapors being compressed in a constant volume compressor and liquefied in solar receivers

62. Procedure for improving the work of compressors in a PTS as per claim 1, characterized by the fact that by making notches in the cylinder cover the air that remains in the cylinder at the end of piston path is transferred on the other side of the piston

63. Procedure for improving the usage of pneumatic and hydraulic equipments, characterized by the fact that on their feeding pipe there is a caged turbine as per claim 46 instead of usual elements for capacity regulation

64. Thermodynamic system as per claim 1, characterized by the fact that it has hot receivers placed on the roof and the sunny side of a building and cold receivers placed on the shadowed side, inside compartments formed in the thermal outer cover

65. Thermodynamic system as per claim 1, characterized by the fact that it has hot receivers placed on the sunny side (or under the incidence of focusing mirrors) of a wall, an embankment or a dam and the cold receivers are placed on the ground in a shadowed area, in the ground, in the water of a river, of a lake or of the sea

66. Thermodynamic system as per claim 1, characterized by the fact that it has hot receivers setup in the wearing layer of a road or highway, and the cold receivers buried deeper in the ground.

67. Thermodynamic system as per claim 1, characterized by the fact that it has hot receivers setup on a fixed or floating structure on a lake or a river, while the cold receivers are setup under the water

68. Thermodynamic system as per claim 1, characterized by the fact that part of its receivers are the blades of a hydraulic or wind turbine

69. Thermodynamic system as per claim 1, characterized by the fact that the working agent is compressed in an isochoric-isobar compressor, then is heated from a heat source and afterwards it expands in a classical or caged turbine or in a pneumatic engine

70. Thermodynamic system as per claim 1, characterized by the fact that the working agent is compressed in a classical compressor or as per claims 35 to 43, then is heated from a heat source and afterwards it expands in a classical or caged turbine or in a pneumatic engine

71. Thermodynamic system as per claim 1, characterized by the fact that the working agent is a refrigerant compressed in a classical compressor or as per claims 35 to 43, then is heated from a heat source and afterwards it expands in a classical or caged turbine or in a pneumatic engine, the first part of the expansion happening with the atomization of a gas that liquefies at the respective temperature

72. Thermodynamic system as per claim 1, characterized by the fact that it is made of a recuperator with refrigerant in which the receivers of a double-gamma Stirling engine are submerged, and on the gas pipe a constant volume compressor is setup, whose cold walls are the cold source for other double-gamma Stirling engines.
